(19) United States
(12) Patent Application Publication
(10) Pub. No.: US 2015/0121185 A1
(43) Pub. Date: Apr. 30, 2015

(54) PORTFOLIO MANAGEMENT SYSTEM

(71) Applicant: Reed Technology and Information Services, Inc., Horsham, PA (US)

(72) Inventors: Christopher L. Holt, Edina, MN (US); Katherine M. Scholz, Edina, MN (US)

(73) Assignee: Reed Technology and Information Services, Inc., Horsham, PA (US)

(21) Appl. No.: 14/524,562

(22) Filed: Oct. 27, 2014

Related U.S. Application Data
(60) Provisional application No. 61/896,410, filed on Oct. 28, 2013.

(51) Int. Cl. G06F 17/21; G06F 3/0481; G06F 17/24

(52) U.S. Cl. CPC G06F 17/211; G06F 17/246; G06F 3/04817
USPC 715/212

(57) ABSTRACT

A method for displaying a graphical representation of a classification of a set of patent applications into a plurality of categories according to an attribute includes receiving, by a processor, a request to generate the graphical representation of the classification of the set of patent applications into the plurality of categories according to the attribute. The method further includes, in response to receiving the request, automatically displaying the graphical representation of the classification of the set of patent applications into the plurality of categories according to the attribute on a display device. The graphical representation includes a plurality of patent document icons. Each of the plurality of patent document icons corresponds to one of the set of patent applications. Each of the plurality of patent document icons graphically represents that the patent application associated with the patent document icon is classified in a category of the plurality of categories.

### CROSS-REFERENCE TO RELATED APPLICATION

This application claims the benefit of U.S. Provisional Application No. 61/896,410, filed Oct. 28, 2013.

### BACKGROUND

Many companies and law firms may experience difficulty in managing and tracking portfolios of patent applications and/or issued patents. Companies and law firms may desire to efficiently prosecute patent applications from filing through issuance. Companies and law firms may also desire to reduce patent application prosecution costs while obtaining high quality issued patents.

Patent portfolio managers or others interested in collections of patent applications may wish to identify problem patent applications (or patent applications that may become problem patent applications) and understand why such patent applications may be experiencing or may experience problems during patent prosecution. For example, it may be desirable to identify patent applications assigned to a patent examiner that allows a small proportion of patent applications examined by the examiner, or assigned to a patent examiner with a large RCE backlog.

Accordingly, a need exists for methods and systems for managing a portfolio of patent applications and to drill down on particular patent applications of interest.

The discussion above is merely provided for general background information and is not intended to be used as an aid in determining the scope of the claimed subject matter.

### SUMMARY

In one embodiment, a computer implemented method for displaying a graphical representation of a classification of a set of patent applications into a plurality of categories according to an attribute includes receiving, by a processor, a request to generate the graphical representation of the classification of the set of patent applications into the plurality of categories according to the attribute. The method further includes, in response to receiving the request to generate the graphical representation, automatically displaying the graphical representation of the classification of the set of patent applications into the plurality of categories according to the attribute on a display device. The graphical representation includes a plurality of patent document icons. Each of the plurality of patent document icons corresponds to one of the set of patent applications. Each of the plurality of patent document icons graphically represents that the patent application associated with the patent document icon is classified in a category of the plurality of categories.

In another embodiment, a computer implemented method of displaying a graphical representation of a plurality of predicted prosecution events for a patent application includes receiving, by a processor, a request to generate the graphical representation of the plurality of predicted prosecution events for the patent application. The method further includes predicting the plurality of predicted prosecution events for the patent application. The method further includes, in response to receiving the request to generate the graphical representation, automatically displaying the graphical representation of the plurality of predicted prosecution events for the patent application on a display device. The graphical representation includes a plurality of nodes. Each of the plurality of nodes corresponds to one of the plurality of predicted prosecution events.

These and various other features and advantages that characterize the claimed embodiments will become apparent upon reading the following detailed description and upon reviewing the associated drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates a schematic diagram of an information-gathering environment, according to one or more embodiments shown and described herein;

FIG. 2 illustrates a schematic representation of a data collection, according to one or more embodiments shown and described herein;

FIG. 4 illustrates a filter screen, according to one or more embodiments shown and described herein;

FIG. 5 illustrates a heat map displayed on a patent portfolio management interface, according to one or more embodiments shown and described herein;

FIG. 6 illustrates a patent portfolio management user interface filter screen, according to one or more embodiments shown and described herein;

FIGS. 7A-7C illustrate patent application heat maps, according to one or more embodiments shown and described herein;

FIG. 8 illustrates a single case interface, according to one or more embodiments shown and described herein;

FIG. 9 illustrates a patent portfolio management user interface filter screen, according to one or more embodiments shown and described herein;

FIG. 10 illustrates multiple patent applications heat maps displayed on a user interface screen, according to one or more embodiments shown and described herein;

FIG. 11 illustrates a heat map interface screen, according to one or more embodiments shown and described herein;

FIGS. 12A-12C illustrate a heat map interface screen with sorting axes, according to one or more embodiments shown and described herein;

FIG. 12D illustrates a comparative view including a window including a larger version of the thumbnail of FIG. 12C, according to one or more embodiments shown and described herein;

FIG. 12E illustrates a briefcase window that shows a visual depiction of saved filter sets, according to one or more embodiments shown and described herein;

FIG. 13 illustrates a budget management selection interface screen, according to one or more embodiments shown and described herein;

FIG. 14 illustrates a budget criteria management interface screen, according to one or more embodiments shown and described herein;

FIG. 15A-C illustrates a single application event prediction interface screen, according to one or more embodiments shown and described herein;

FIG. 16 illustrates a single application event divergence detected interface screen, according to one or more embodiments shown and described herein; and

FIG. 17 illustrates a portfolio budget prediction interface screen, according to one or more embodiments shown and described herein.

### DETAILED DESCRIPTION

Embodiments disclosed herein include computer implemented methods for displaying a graphical representation of a classification of a set of patent applications into a plurality of categories according to an attribute, and computer implemented methods for displaying a graphical representation of a plurality of predicted prosecution events for a patent application. By displaying a graphical representation of a classification of a set of patent applications into a plurality of categories, as described herein, a user may quickly and efficiently understand characteristics of the set of patent applications based on viewing the graphical representation. By displaying a graphical representation of a plurality of predicted prosecution events for a patent application, as described herein, a user may quickly and efficiently understand a predicted course of prosecution of one or more patent applications by viewing the graphical representation.

### Database of Patent Application Information

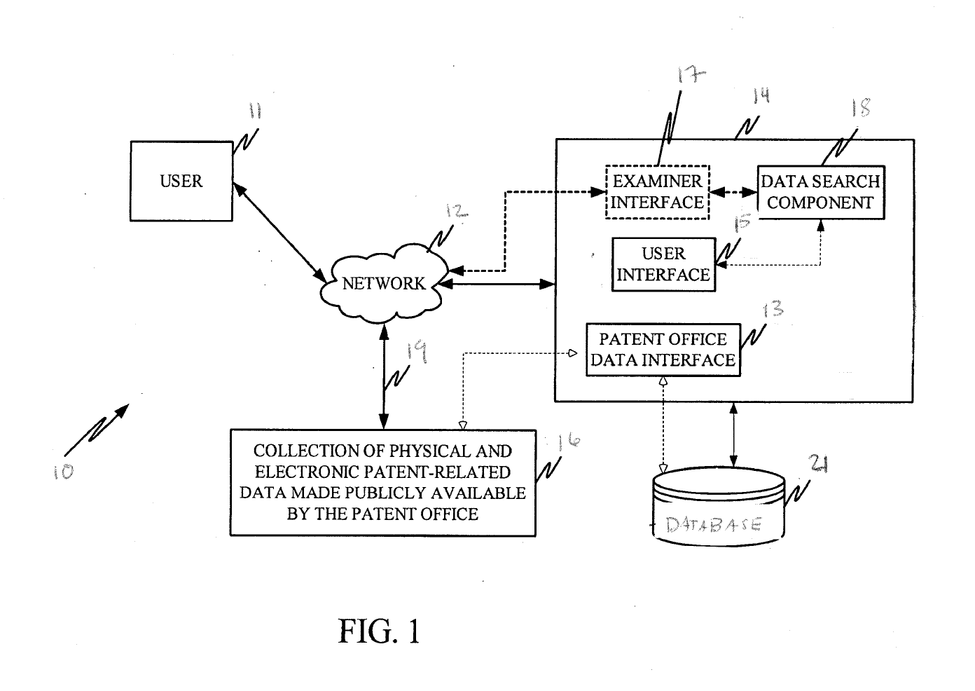

FIG. 1 is a schematic diagram of a system 10 in which a user 11 accesses a patent portfolio management system 14 via a network 12. The user 11 may utilize a client computing device (including among other elements at least one processor and at least one non-volatile memory module) to access the patent portfolio management system 14. The patent portfolio management system 14 includes one or more computing devices (each of which includes a processor and at least one memory module), which in some embodiments may be server-type computing devices. The user 11 interacts with the patent portfolio management system 14 in order to acquire information pertaining to a portfolio of patent applications, as will be described in detail below. The patent portfolio management system 14 is configured to provide the user 11 with requested information, such as information retrieved by the patent portfolio management system 14 from a database 21. The patent portfolio management system 14 and the user 11 communicate over the network 12, which is illustratively, but not necessarily, the Internet. The patent portfolio management system 14 is illustratively, but not necessarily, implemented as an Internet web site. The database 21 may include user account information, information pertaining to a plurality of patent applications, and/or a collection of patent documents, which may be indexed by a variety of different bibliographic data. The bibliographic data may include a patent application number, an examiner name, an art unit name, a filing date, a patent number if a patent has issued, assignee information, law firm data associated with a law firm that filed or is prosecuting the application, a title, keyword information, or the like.

While the user 11 could be any person interested in the patent system or process, in some embodiments the user 11 is an inventor, an agent representing an inventor, an agent representing an entity to whom patent rights have been assigned, a patent portfolio manager, an employee of a company or organization to which a patent application is assigned, a patent examiner, an employee of a law firm, or any other user interested in obtaining information pertaining to one or more patent applications.

Patent offices typically make at least some patent-related data publicly available. Data collection 16 represents that data. Some of the data may be electronically available and/or available over a computer network (e.g., the Internet). Some of the data may be available in a non-electronic format and/or through means other than a computer network, (e.g., physical copies purchased for a fee, data purchased or obtained on a physical storage mechanism, etc.). As is generally indicated by line 19, when components of data collection 16 are made electronically available to the public, the user 11 and the patent portfolio management system 14 can retrieve that data over the network 12, often through a database querying process. It should be noted, however, that in some cases data may be available through some other electronic means, such as through downloads from an FTP server.

The patent portfolio management system 14 includes a number of components. Specifically, the patent portfolio management system 14 includes a patent office data interface 13 that is configured to interact with publicly available sources of patent examiner information and store, or otherwise catalog, the public information in the database 21, which may be a part of the patent portfolio management system 14 in some embodiments or external to the patent portfolio management system 14 in other embodiments. In one embodiment, the patent office data interface 13 includes, an automated algorithm or module that performs automated searching, retrieval, cataloging and storing of publicly available data in such a way as to facilitate efficient storing and speedy recollection of such information based on serial numbers, examiner names, assignee names, or any other category. For example, in one embodiment, the patent office data interface 13 may include a crawler, that periodically, or continuously, crawls through sources of publicly available information looking for examiner-written documents, or other suitable sources of information that become available and have not been previously stored in the database 21. When the patent office data interface 13 finds such information, it may download, categorize and/or store the information in the database 21.

The patent portfolio management system 14 also includes a user interface module 15 that provides a user interface to standard users of the patent portfolio management system 14. In some embodiments, the user interface module 15 causes the patent portfolio management system 14 to display information, such as the graphical user interfaces and information described below, on a display device, such as the display device of a client computing device used by the user 11. Additionally, the patent portfolio management system 14 may optionally include an examiner interface 17 that may allow patent examiners to log in and interact with the patent portfolio management system 14. The patent portfolio management system 14 also includes a data search component 18. The data search component 18 that may comprise a local search engine, or a module that simply formulates remote search requests to be executed to retrieve information from the database 21 and/or remote sources of publicly available data. In some embodiments, the data search component 18 is coupled to the user interface module 15 and/or the examiner interface 17.

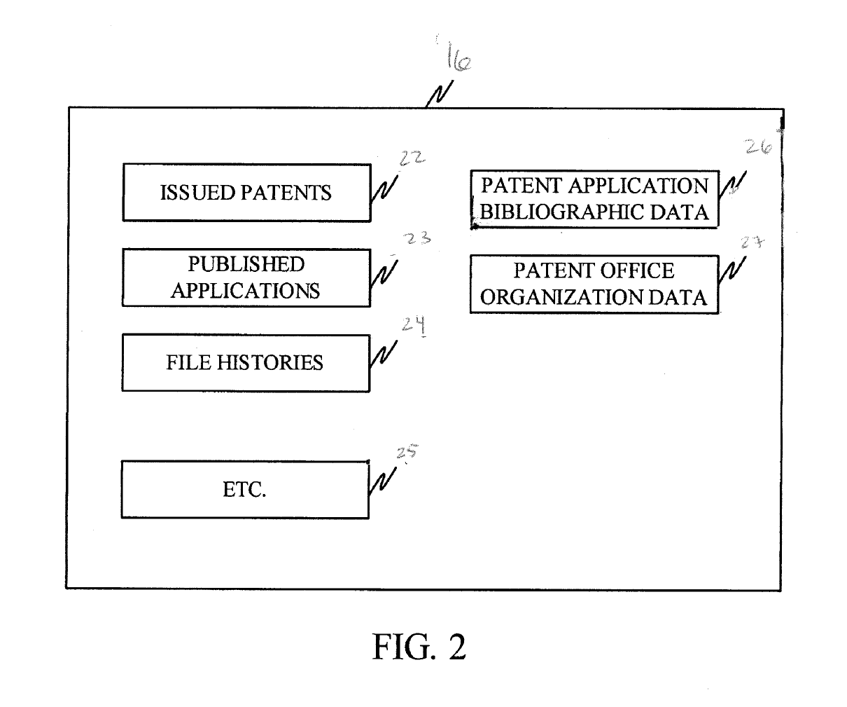

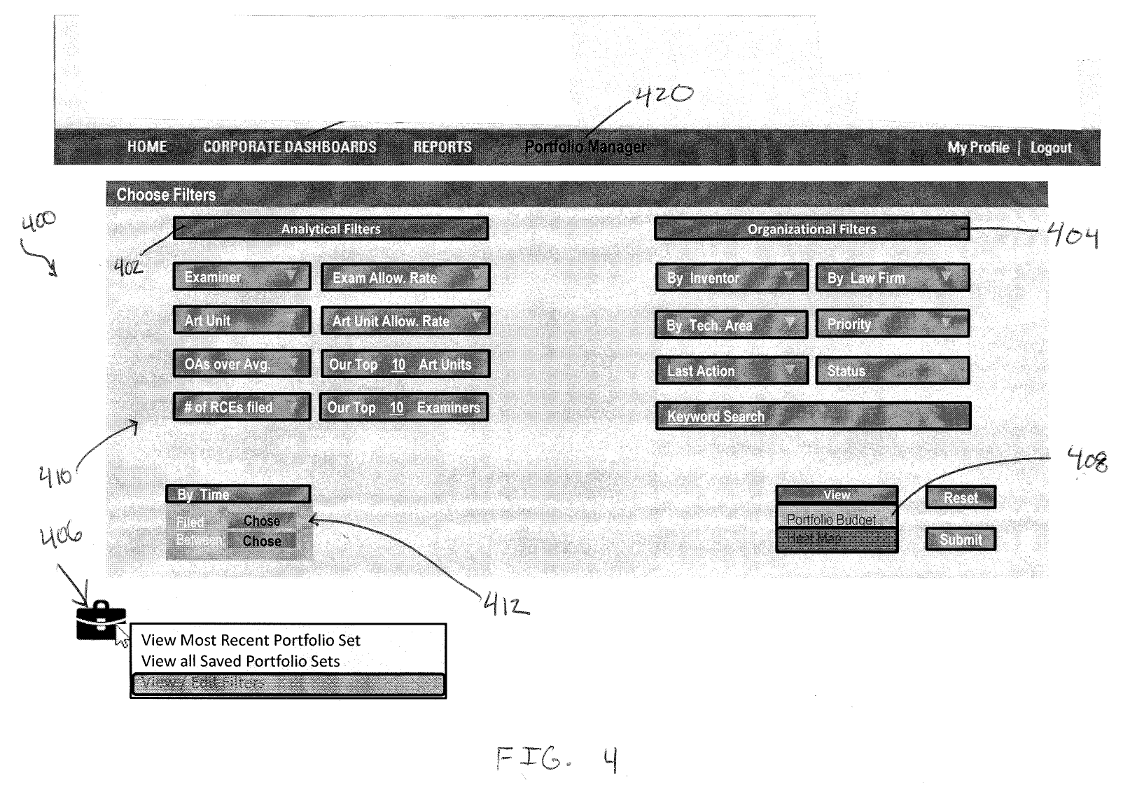

FIG. 2 is a schematic representation of data collection 16. In some embodiments, the data collection stores information pertaining to patent applications pending before the United States Patent and Trademark Office (USPTO). However, it should be noted that embodiments are not limited to US patent documents, as the embodiments described herein may be used in tracking and displaying information pertaining to patent applications pending before foreign patent offices, such as the Japanese Patent Office, the European Patent Office, or the like. In the context of United States patent applications, the USPTO provides public access to very large amounts of patent-related data. Much of this data is freely available through their website (www.uspto.gov) either through database querying, FTP downloads, requests for non-electronic copies, requests for data on an electronic storage means, or some other means. Some of the available data shown in FIG. 2 includes data pertaining to issued patents 22, published patent applications 23, patent application file histories 24, patent application biographic data 26 and patent office organization data 27. Other data is represented at 25.

Thus, it may technically be possible for a user 11 to obtain some level of information about a portfolio of patent applications from the data collection 16. However, in many cases, there is no efficient means for the user 11 to navigate through the data collection 16 to view aggregate data pertaining to a patent portfolio.

As a patent application moves through the patent office, a trail of documents is created. This trail of documents collectively make up what is called a file history. Each application has its own file history. Each file history is identifiable at least by the unique serial number assigned to the corresponding application. Every serial number, including those that correspond to an issued patent, has an associated file history.

At least some file histories are made available to the public. For example, in the United States, through a search portal located on the Patent Office Web Site, a user can electronically retrieve and review documents in at least some file histories. In most cases, file histories are retrieved based on input from the user in the form of an application serial number or a patent number. Some file histories may not be publicly available in electronic format but may be available by request in hard copy. Some file histories may not be publicly available at all. For example, in the United States, many file histories are held in confidence by the Patent Office for the first eighteen months after filing. Some file histories are maintained in confidence until issuance of a related patent.

It is common for a file history to contain one or more documents authored by an examiner assigned to the associated application. For example, during the examination process, an examiner will issue documents called Office Actions. These Office Actions are part of the file history.

### Patent Portfolio Management System

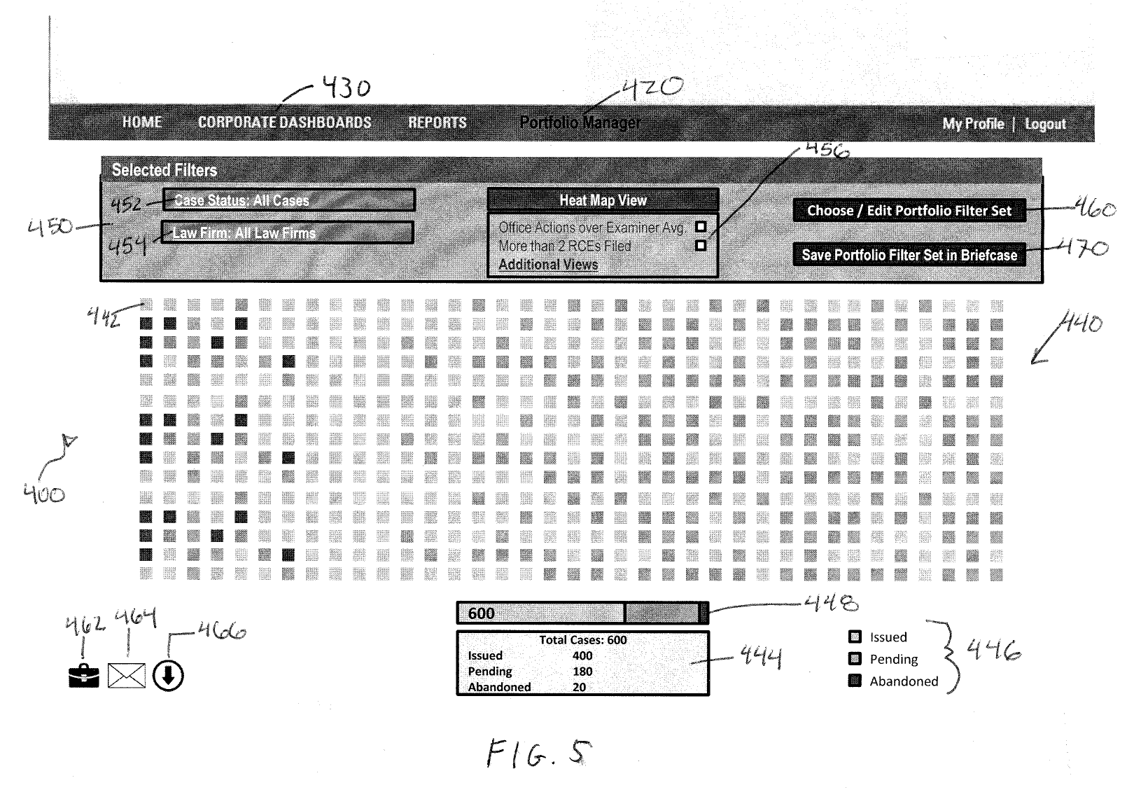

FIG. 4 shows a user interface 400 associated with a patent portfolio management system, in accordance with one embodiment.

As shown in FIG. 4, several different filter options are available to filter a designated portfolio set. One distinct problem facing companies, individuals and law firms that deal with a large number of patent applications on a yearly basis is the ability to understand and visualize the portfolio that they are responsible for. One particularly difficult cost management concern is the ability to identify problem case sets in order to keep a budget on track efficiently and manage the prosecution of those problem cases more carefully. One distinction (particularly for corporations) is the ability to distinguish between law firms, art units, and different internal organizational structures to figure out where the patent process is working efficiently and not efficiently within their organization. For example, one corporation may find that Law Firm A prosecutes patents more efficiently and with lower costs than Law Firm B in a particular art unit against a particular Examiner. In this example, the corporation may want to switch more of its work to Law Firm A from Law Firm B in order to minimize expenses related to patent prosecution.

The user interface 400 may be used to access information pertaining to a patent database that indexes granted and pending patent applications by a variety of USPTO metrics, for example assignee, examiner and art unit. In one embodiment, the patent applications and associated documents and data are scraped from the USPTO databases. In another embodiment, the patent applications and associated documents and data are obtained from other sources. For example, in one embodiment, a customer using the database may provide internal metrics—for example, business unit or internal priority level. FIG. 4 shows a series of exemplary analytical and organizational filters available based on metrics assigned to applications in the database. Additionally, some of the filters arise from a plurality of metrics—for example, cross referencing applications assigned to a particular assignee and across art units allows for the option to filter by “Top 10 Art Units” for a particular assignee.

In one embodiment, the database also collects and retains documents, also sorted and indexed by a series of metrics. In this way, for each application in the database, a user of the patent portfolio management interface can also pull associated documents, for example Office Actions issued by the USPTO and responses filed by prosecuting attorneys. Additionally, as these associated prosecution documents are pulled, the status of the case is updated, allowing for a user of the patent portfolio management system to sort cases by the latest action, or the number of Office Actions or RCEs that have been filed in a particular case. Discussed below are a series of exemplary filtering options. However, the embodiments described herein are not limited to the filtering options discussed or shown in the figures, but could also comprise any additional analytical or organizational filters.

In one embodiment, the patent portfolio management user interface is accessible to a user on a subscription basis. Once a user signs up for access, the user, for example a corporation or law firm, is given access to an online dashboard that is connected to the database, and which comprises all of the cases that the user is responsible for (for example, all of the cases assigned to the user's corporation), wherein the term ‘case’ refers to a pending patent application, abandoned patent application, or granted patent. As can be seen in FIG. 4, a user is given access to a corporate dashboard (or law firm dashboard, if the user is a law firm), that details their cases, law firms prosecuting cases (or assignees for whom cases are being prosecuted), and other pertinent information. The user is also given access to a portfolio management tab, as shown in FIG. 4, that allows a user to access, view, or manipulate cases that have already been placed into a subset of all the cases in the database. In this manner, a user can generate statistics, for example, by art unit or examiner, specific to their cases, and not specific to the general body of patent statistics.

In one embodiment, the documents and data in the database that is accessed by the user through the dashboard are housed in servers owned by the dashboard provider, and the user is given access to the online dashboard in a software-as-a-service model. The data comprising the database is, in one embodiment, located in remote servers. When a user enters a request through the user interface, wherein the request comprises one or more filters designed to narrow a case set to a particular desired subset, that request is forwarded by the dashboard software to the remote servers, wherein a processor on the server end sorts through the database to find the subset of cases that meet the filter requirements and return those to the user via a graphical user interface, such as the heat map interface described below.

The user interface 400 of FIG. 1 comprises a filter selection interface 410 that is displayed in response to a user selecting the portfolio management tab 420. The user interface 400 also includes the corporate dashboard 430 tab, which, in response to user selection of the tab, allows a corporation to view internal patent application structure. As shown in the filter selection interface 410, the user interface 400 may facilitate the setting of a variety of analytical filters via the analytical filter setting portion 402 and the setting of a variety of organizational filters via the organizational filter setting portion 404. For example, a user of the user interface 400 may choose to filter the entire portfolio down to applications within its top ten art units, and cases that have last received a final action. While the functionality described herein assumes the user is a portfolio manager for a corporation, it is to be understood that the same functionality is appropriate and useful for lawyers prosecuting patents, patent prosecution firms and, potentially, even the USPTO itself.

The user interface 400 also includes a briefcase button 406 that allows a user to save a filter set or view their most recent portfolio filter sets and/or look at all saved portfolio filter sets. In this way, a corporation comparing law firms (for example, Law Firms A and B) may want to do so over time, by retaining the same filters (for example, Law Firm A in a specific art unit against Law Firm B in a specific art unit) and, for example, reviewing the results every six months to determine which law firm is acting more efficiently; or if Law Firm B has fixed its efficiency loopholes and has become as cost efficient as Law Firm A.

An additional aspect of the user interface 400 is the view selection interface 408 wherein a user can select to view a budget view or a heat map view. A budget view allows a user to gain insight into the cost structure behind their portfolio and see, in dollar amounts, how much different application sets are costing. A heat map view, alternatively, uses colors (or, in another embodiment, shapes or other appropriate delineators) to indicate where problem areas, or ‘heat’ is concentrated. For example, one heat map may show, for a series of applications, a number of RCEs that have been filed in each case. Cases with more RCEs filed will be shaded a darker color, in this example, than those with fewer RCEs filed during the prosecution history.

Another filter option is the ability to set a time filter using the time filter interface 412 wherein a user may filter the set of applications to those filed either from a specific date (for example, to look at applications filed since the implementation of the America Invents Act) or to look at applications filed between a specific set of years (for example, to hone in on applications associated with an acquisition period).

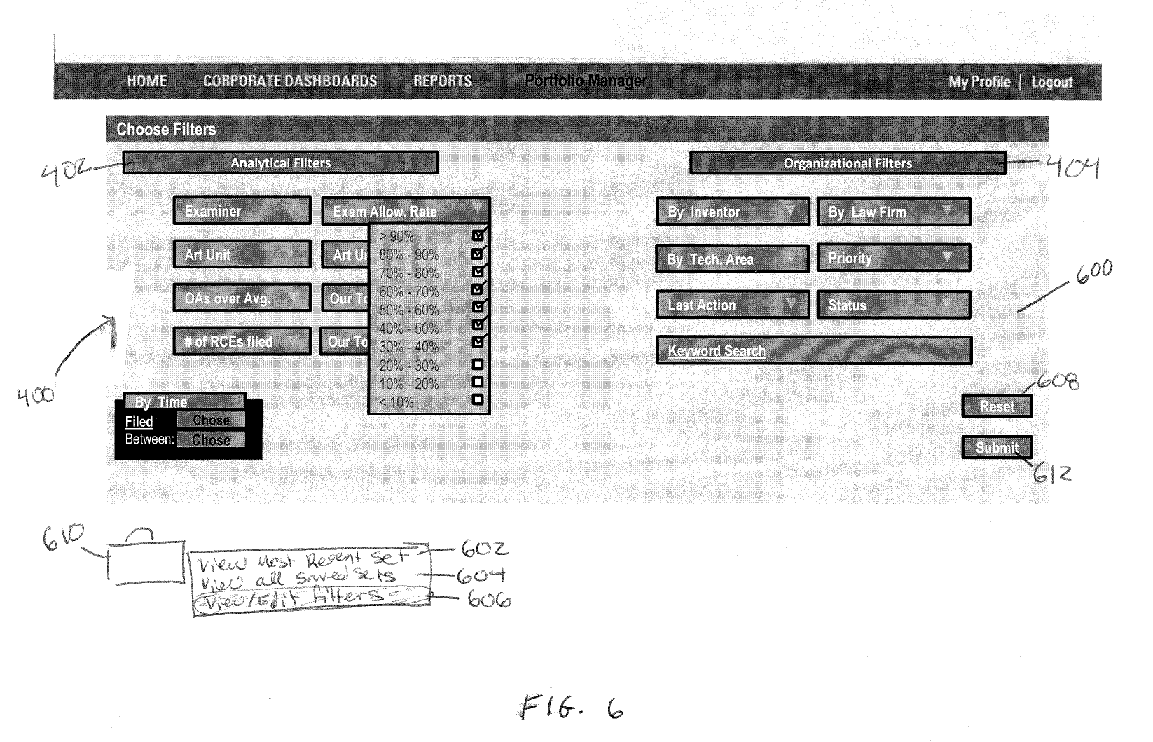

After selecting a variety of analytical and organizational filters to select a set of patent applications for further analysis, a user may be presented a heat map graphical representation on a user display device, for example, the heat map graphical representation depicted in FIG. 5.

Referring now to FIG. 5, the heat map graphical representation 440 displays the set of applications that satisfy the selected filter criteria set by the user. For example, as shown in FIG. 5, an exemplary user of the user interface has selected to see all case statuses and cases corresponding to all law firms. As described above, in accordance with one embodiment, a user may choose to limit these filters further (for example, by selecting only pending cases via the case status filter 452, or selecting cases specific to a certain law firm via the law firm filter 454). A user may also further edit the returned application set by clicking on the edit portfolio filter set button 460 or, if this is the exact filter set the user to save and view at a later date, the user may choose to save the filter set by clicking on the save button 470.

In embodiments, the heat map graphical representation 440 may be output by a computer implemented method for displaying a graphical representation of a classification of a set of patent applications into a plurality of categories according to an attribute. In some embodiments, a computer implemented method for displaying a graphical representation of a classification of a set of patent applications into a plurality of categories according to an attribute includes receiving, by a processor, a request to generate the graphical representation of the classification of the set of patent applications into the plurality of categories according to the attribute. For example, in some embodiments, the request may be received in response to a user selecting to view a heat map in the view selection bar (FIG. 4). In response to receiving the request to generate the graphical representation, the graphical representation of the classification of the set of patent applications into the plurality of categories according to the attribute may be automatically displayed on a display device (e.g., a display device of a client computing device used to access the portfolio management system described herein). As shown in FIG. 5, the graphical representation includes a plurality of patent document icons 442. Each of the plurality of patent document icons 442 corresponds to one of the set of patent applications. Each of the plurality of patent document icons 442 graphically represents that the patent application associated with the patent document icon is classified in a category of the plurality of categories.

In the embodiment depicted in FIG. 5, the graphical representation of the classification of the set of patent applications into the plurality of categories according to the attribute is a heat map graphical representation in which each of the plurality of patent document icons 442 graphically represents that the patent application associated with the patent document icon is classified in a category of the plurality of categories based on a color of the patent document icon. The heat map shown in FIG. 5 is arranged in a grid. The plurality of patent document icons 442 are sorted in the grid by at least one organizational parameter, such as by date, by prosecution status, by number of office actions over an average, or the like. In some embodiments, such as the embodiment depicted in FIG. 5, the attribute is application status, the plurality of categories include an issued patent category, a pending application category, or an abandoned application category, and each of the plurality of patent document icons 442 graphically represents that the patent application associated with the patent document icon is classified in the issued patent category, the pending application category, or the abandoned application category.

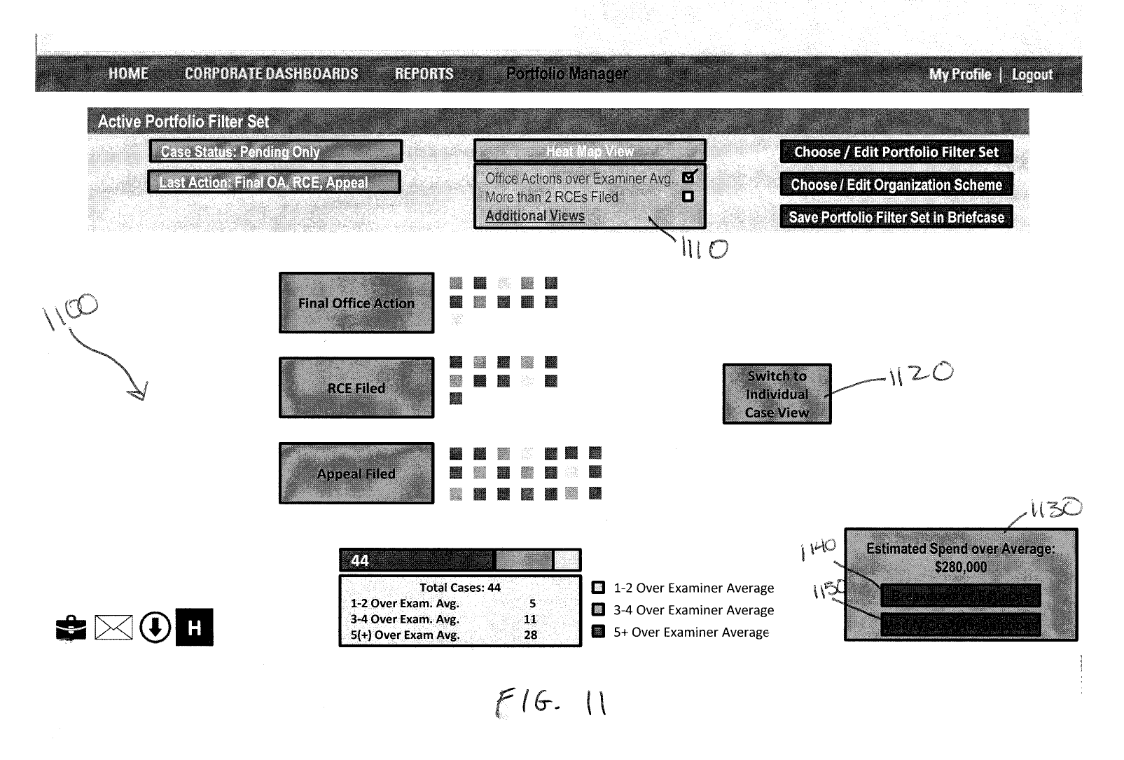

In other embodiments (e.g., FIG. 10), the attribute is a patent prosecution metric (specifically whether a particular application is above an average for an examiner, at an average for an examiner, or above an average for an examiner), the plurality of categories include a plurality of patent prosecution metric categories, and each of the plurality of patent document icons graphically represents that the patent application associated with the patent document icon is classified in one of the patent prosecution metric categories.

In some embodiments, the set of patent applications displayed in the graphical representation are filtered from a universe of patent applications according to at least one filter criteria, such as in embodiments in which the user sets one or more filters via the filter selection interface 410 of FIG. 4. The at least one filter criteria can include an examiner filter, an art unit filter, an examiner allowance rate filter, an art unit allowance rate filter, an office actions over average filter, a top art units filter, a number of RCEs filter, an inventor filter, a law firm filter, a technology area filter, a priority filter, a last action filter, or a status filter.

All of the applications that match the criteria of the selected filters (both organizational and analytical) will be returned in a grid-like configuration as shown in FIG. 5. However, other configurations may be shown in other embodiments (for example, a pie chart in accordance with one embodiment). Additionally, the individual cases are shown with space separating them from other cases around them. However, in another embodiment, these grid sections could be shown directly adjacent to one another. Additionally, while shown in FIG. 5, the heat map is composed of square boxes exemplifying each returned case; additionally, rectangles, circles, triangles, or other shapes could be used to show the different cases. Additionally, while these case status are distinguished by color (as shown in FIG. 5), alternatively these cases could be distinguished based on different shapes (for example, instead of abandoned cases being the darkest color, abandoned cases could, instead, be triangles, whereas issued cases are circles) or based on shading (for example, issued cases are dotted whereas pending cases are solid and abandoned cases are striped).

A summary of all of the cases returned is shown in the status summary 444 as shown in FIG. 5, in accordance with one embodiment. For example, the return set shown in FIG. 5, comprises 400 issued patents, 180 pending patent applications, and 20 abandoned applications. The summary is also represented by the status bar 448, which shows a color breakdown of the percentage of cases corresponding to each section wherein the colors are identified by status legend 446. As shown in the heat map view selection section 456 of FIG. 5, no specific heat map has been selected. Exemplary heat map views which may be chosen in the heat map view selection section 456 may include Office Actions over an Examiner's average or cases where more than two RCEs have been filed, as shown. However, additional heat maps could be shown (for example, cases corresponding to Examiners with allowance rates of less than 10% as compared to cases assigned to Examiners with over 40% or over 90%).

The briefcase button 462, the e-mail button 464, and the download button 466 shown in FIG. 5 allow a user to save, e-mail, or download, respectively, the filter set shown in the heat map view. These sharing features allow a user of the user interface to share their finding with, for example, outside counsel. In this way, a user of the user interface can more effectively manage their portfolio in a hands-on manner. Specifically, as shown via FIGS. 4 and 5, the user is more able to rapidly find cases that correspond to a specific filter set within a matter of seconds or minutes as opposed to the current convention, which would require a user to correspond with a variety of outside counsel to collect information on all of their cases and then troubleshoot from there. Additionally, it is difficult even with such information to gain insight into specific attributes of different Examiners and art units, as will be discussed in further detail. For example, if a portfolio manager finds that his or her company has 10 pending cases against a particular examiner, the portfolio manager may want to share this information with all outside counsel responsible for those 10 cases. In this example, if the portfolio manager sees that another case has been allowed by that examiner, the portfolio manager can also share that information with outside counsel thus potentially speeding the prosecution along of the other 10 cases. Additionally, if the portfolio manager noted that the allowed case was only obtained after an appeal, he or she may want to indicate to outside counsel that cases against that Examiner should be appealed more frequently, as opposed to filing RCEs.

In one embodiment, selecting the briefcase button 462 may store the set of filters corresponding to the cases viewed on the dashboard. In another embodiment, selecting the briefcase button 462 may also save a screenshot indicating the number of cases returned and the date the user searched for those filters. This allows the user to see a visual representation over time indicating whether or not the number of problem cases identified by the filters has increased or decreased since the last time the user searched the database for cases corresponding to those filters. In another embodiment, the briefcase also stores an indication of the number of cases corresponding to each saved set of filters on the date those saved set of filters were run. In this way, a user can easily track the number of cases that correspond to each filter set over time to determine whether the number of cases is growing, shrinking, or remaining steady over time.

FIG. 6 shows an edit filter screen 600 of the user interface 400, in accordance with one embodiment. As shown, a user of the previous set has chosen to click on the briefcase button 610, causing a pop-up of options to be displayed. In another embodiment, the pop-up shown in FIG. 6 is activated by a user hovering over, but not clicking on, the briefcase button 610.

As shown in FIG. 6, the user is limiting the number of cases to be returned by Examiner allowance rate. Allowing insight into such Examiner-specific or art unit-specific information may allow companies to truly understand what their chances are of obtaining a patent as compared to an estimated price of obtaining that patent and, additionally, the quality of claims that may or may not be allowed. For example, in FIG. 6, if the user instead chose to look at cases where Examiners had a less than 10% allowance rate in combination with cases that have received more than one RCE, the user could decide whether or not the cases that are returned are worth the trouble of prosecuting as the chance of getting a patent is slim and the cost will likely be high.

Once the user has made the alterations they desire through the edit filter screen 600, the user can click on the submit button 612 to reconfigure the heat map. Additionally, if the user wants to start from scratch, they can click the reset filters button 608, which would reset the filters back to default. In one embodiment, these defaults are set by a user in a settings menu.

One of the aspects of the briefcase button 610 shown in FIG. 6 is the ability that it gives to users to click the view most recent set button 602 in order to review a previously viewed portfolio set and see any changes over time.

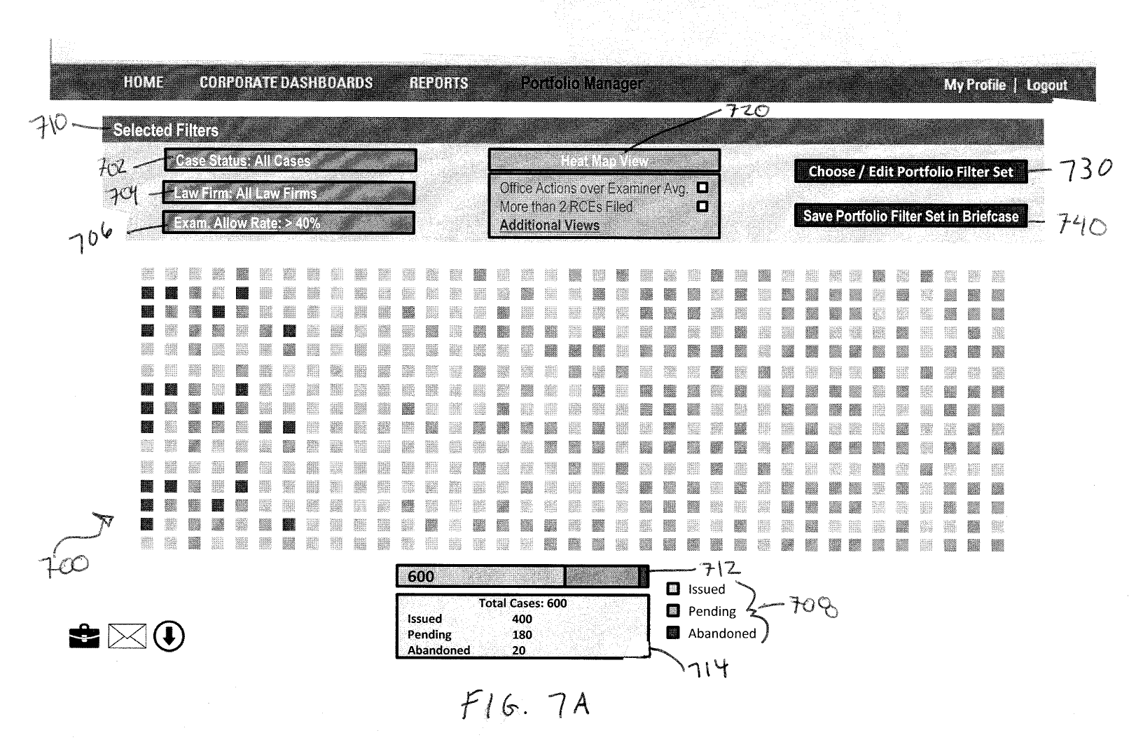

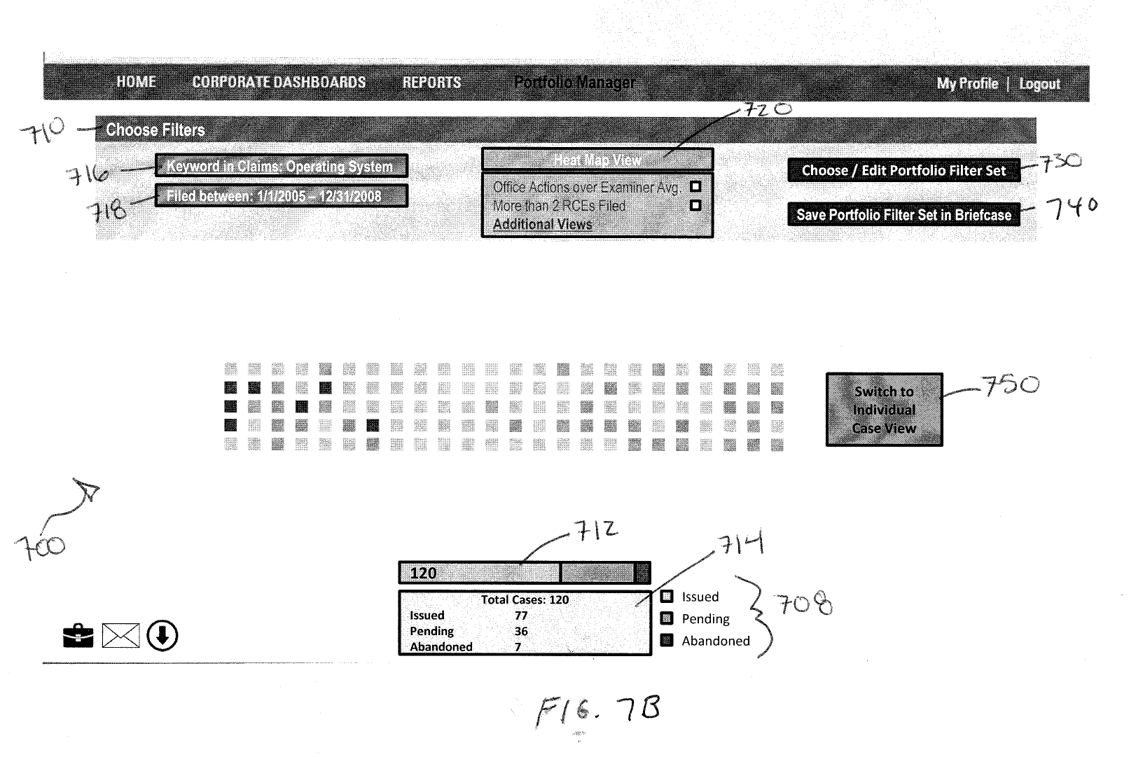

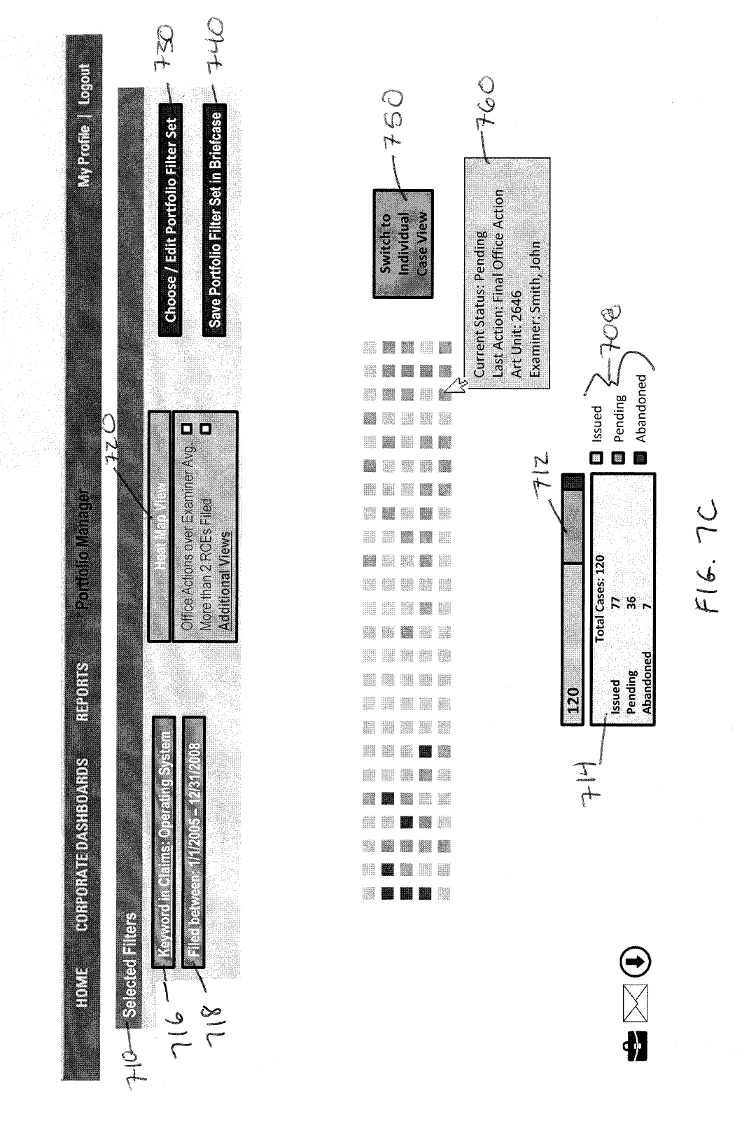

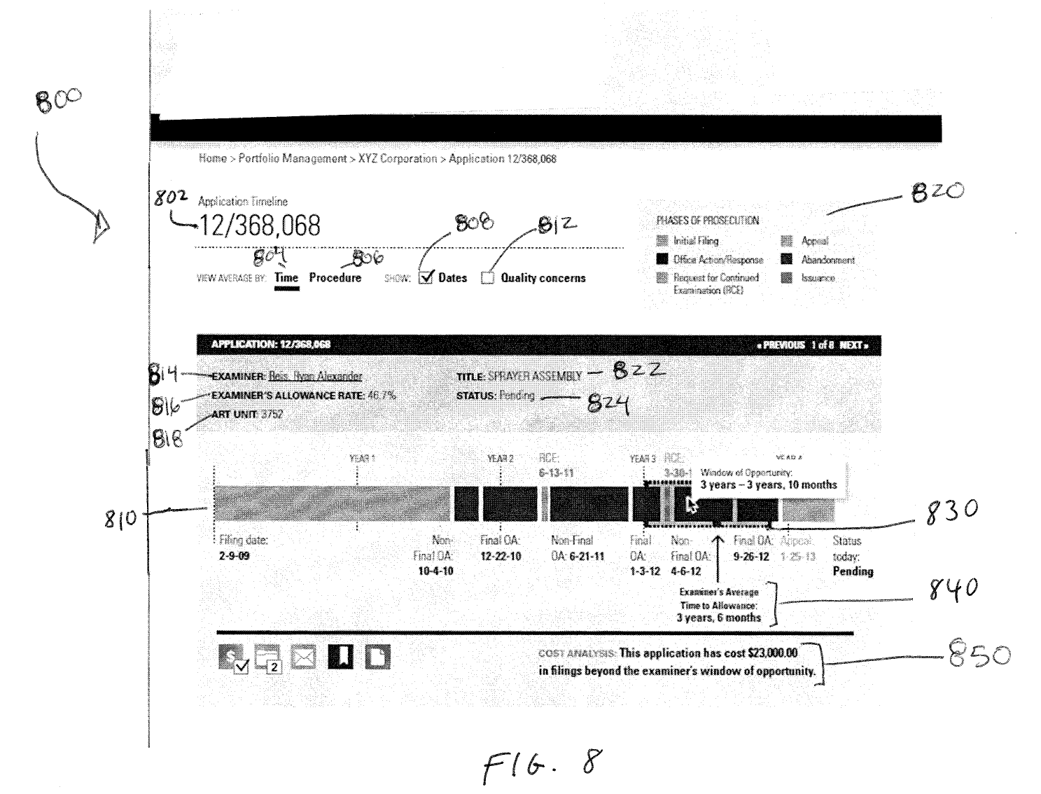

FIGS. 7A, 7B and 7C show additional heat map graphical representations with different filters set. FIG. 7A shows a heat map interface in which a case status filter has been set to all cases, a law firm filter has been set to all law firms, and an examiner allowance rate filter has been set to greater than 40%. A status legend 708 shows what the different color schemes correspond to. As shown in FIGS. 7A-7C, different colors correspond to issued, pending and abandoned applications. However, as described previously, colors are only shown as one exemplary means of distinguishing different types of cases. Shapes, shading, or size differences could also be used, in other embodiments, to distinguish between types of cases matching the criteria. A summary of the cases returned by the filter set is shown in the status summary 714 and a visual representation of this is shown through the status bar 712.

As shown in FIG. 7B, another filter that a user of the heat map interface 700 may choose to use is the keyword filter 716 wherein a user can identify a set of patent applications that include a specific keyword in the specification, abstract, or as shown in FIG. 7B, in the claims by use of the keyword filter 716. As shown in FIG. 7B, the user has selected to return cases where the term “operating system” is used in the claim language. Additionally, the user in FIG. 7B has restricted the search to cases that were filed between Jan. 1, 2005 and Dec. 31, 2008. For large companies with complex portfolios, the keyword filter allows an additional means to find what cases correspond to a particular technology developed. And, in the case of potential infringement, allows a portfolio manager to quickly determine which cases may be applicable offensively or defensively.

As shown in FIGS. 7B and 7C, the user also has the option once the filter has returned a sufficiently small number of cases to switch to an individual case view by selecting the switch to individual case button 750. This allows a user to, once the cases have been narrows sufficiently, to have a page by page view of the different cases to get a better understanding as to why different cases, for example, were issued or abandoned. Additionally, as shown in FIG. 7C, a user can get an idea of the individual case statistics by hovering in one embodiment or click on in another embodiment a specific case to display a current status pop-up 760.

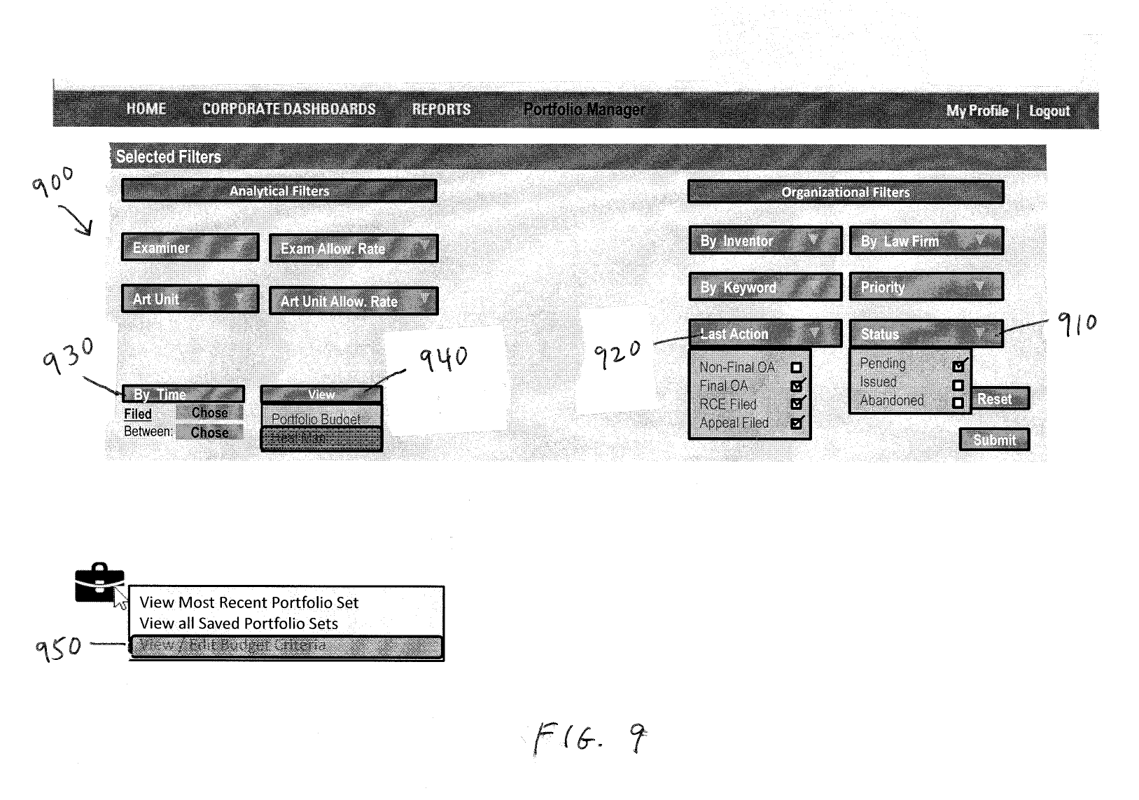

As shown in FIG. 7C, the current status pop-up 760 may, in one embodiment, show a current status of the case, a last action, an art unit, and an Examiner name. However, alternatively, the heat map interface could be configured to display, for example, an internal organization structure, a law firm name, an Examiner allowance rate or any other statistic relevant to a user of the user interface 400. This default set of statistics to return could, for example, be set in a settings menu in one embodiment. While, as shown in FIG. 7C, this current status pop-up 760 is presented as a pop-up, it could alternatively be presented in a split screen format where the current status shows up in another window of the screen and presents more or less information as desired by the user. While, in one embodiment, the user sees current statistics by hovering over a specific case, as shown in FIG. 7C, the user could, alternatively, click on a specific case and be returned with an individual case view as shown in FIG. 8.

Individual case view 800, as shown in FIG. 8, comprises a timeline 810 showing the progress of a case from the filing date to its current status today or, in another embodiment, through issuance or abandonment if the prosecution has ended. Additionally, individual case view 800 includes a prosecution legend 820 which shows what different colors on the timeline 810 correspond to. For example, one section may correspond to the period wherein an Examiner had issued an Office Action and the law firm was responding or the period during which a case stood pending during a request for examination.

Additionally, as shown in window of opportunity 830, the individual case view 800 shows when, if ever, an allowance is most likely to occur on a time-basis measured from the date the application was filed. The window of opportunity 830 is calculated by the database and varies based on Examiner and based on art unit and based on that Examiner's individual statistics within a specific art unit. For example, as shown in FIG. 8, the Examiner average is three years and six months to an allowance; wherein the window of opportunity 830 shows standard deviation above and below that time period. As shown in FIG. 8, this specific case has gone past the window of opportunity and is currently on appeal. For a corporation, the understanding of how many cases have gone beyond this window of opportunity gives an idea of where the corporation is overpaying for its prosecution and gives a good set of candidates of cases to consider for abandonment. Additionally, the Examiner average 800 metric also gives corporations a concrete metric to compare different law firms against each other on an Examiner-specific level and an art unit-specific level. This ability is also useful for corporations in deciding where to shift case responsibility in order to maintain budget efficiency. If one law firm consistently requires 1, 2 or more office action cycles beyond an examiner's average than a second law firm, then the second law firm is more efficient, potentially even if the second law firm charges more per office action response cycle.

Many corporations currently make their prosecution strategy based on a total number of Office Actions allowed per case. For example, abandoning a case after a second final office action is received. However, if, in a specific case, the prosecution has gone beyond an Examiner's window of opportunity and the chance of an eventual allowance is low, a case by case approach is more appropriate than an overall strategy where a patent portfolio comprises multiple art units and covers many Examiners, and where those art units and examiners are likely to have different averages.

Breaking it down in financial terms, the cost analysis 850 shows how much a certain case has gone over or under the average based on the examiner and art unit assigned to that case. This cost analysis 850 is individual to different corporations or law firms and is based on an estimated cost to respond to a specific Office Action and based on current filing fees for the Patent Office. In this case, because the case has gone on appeal beyond the Examiner's average time to allowance, it is currently estimated that this case has cost $23,000.00 beyond what it should have to get to an allowance based on the Examiner's average, allowance time, and average allowance rate. Depending on the Examiner's success rate on appeal, a user may determine that it is better to abandon the case now instead of incur additional expenses.

Some additional statistics present in the individual case view 800 include the application serial number 802 as well as an Examiner name 814, and Examiner allowance rate 816, a current art unit 818, a title 822, and a current status 824. Additionally, a user may, within the individual case views, switch between viewing by time 804 (which is currently shown) and a procedure view 806, which is not shown. This procedure view would, instead of showing the prosecution on a time basis, would show based on a number of Office Actions. In the procedure view, the window of opportunity 830 would encompass a certain number of Office Actions based on the Examiner's average time to allowance with standard deviation above and below.

Additionally, in the individual case view, a user can switch between a date view and a quality concern view by checking the date checkbox 808 or the quality concern checkbox 812, respectively. A quality concern view may, for example, indicate to a user that, for example, in the second Office Action response the claims were amended to include equations or where the claim language has gone past a certain number of words. These different indicia of quality may indicate to an applicant or an owner of the patent that, while a set of claims may yet issue, they may be of such low quality that it is not worth pursuing prosecution further. In another embodiment, quality concerns may indicate where multi-actor problems may be present.

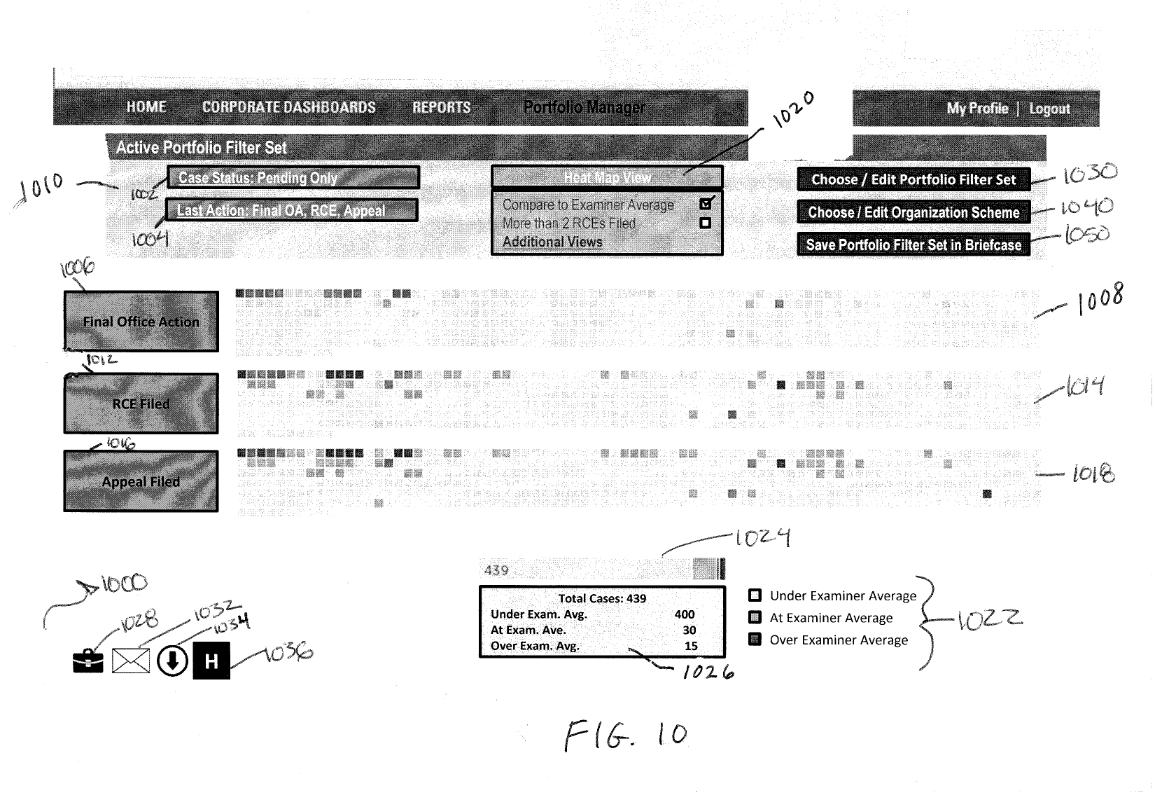

In another embodiment, a user may want to use the user interface 400 solely for budget projection purposes. In this case, the user may utilize the budget filter screen 900 as shown in FIG. 9. Budget filter screen 900 has similar filter options as those discussed previously with respect to the prosecution management system described above, including analytical filters and organizational filters. As shown specifically in FIG. 9, a user may want to sort cases based on status using status filter 910 and based on the last action that has occurred via last action filter 920. As shown in FIG. 9, a user has decided to sort based on only cases that are pending and only cases where a final Office Action, an RCE or an appeal were the last actions to occur. Using these different filters, for example, may give a user of the user interface a better indication of cases where an interview may be necessary for example, or wherein abandonment may be the next logical step. Additionally, a user may choose to use the view selector 940 to view the returned cases as a portfolio budget or as a heat map.

Further, because budgets vary drastically between corporations and based on different criteria, a user of the user interface 400 may want to view or edit budget criteria by selecting the edit budget criteria control 950. For example, cases corresponding to different law firms may have different price structures based on Office Action responses or based on hours taken to prepare a response to an Office Action. Additionally, cases corresponding to in-house counsel may be treated differently cost-wise from cases corresponding to outside counsel. Therefore, selecting the edit budget criteria control 950 to verify budget cost assumptions and, if necessary, to edit budget cost assumptions.

A user may want to be able to see different heat maps corresponding to different filter sets selected. As shown in FIG. 10, the cases selected from FIG. 9 based on the last action taken are sorted into three different heat maps presented to the user in heat map view 1000. Heat map view 1000 includes an active filter set 1010 that shows a user which filters have been applied to the current case, a selected heat map view 1020 wherein a user has chosen to view these cases based on how they compare to individual Examiner averages. Additionally, heat map view 1000 includes an edit filter set button 1030, an edit organizational scheme button 1040, and a save button 1050. By selecting the edit organizational scheme button 1040, a user may be presented with a heat view for each of final Office Action, RCE filed, an appeal file, or to view one heat map comprising all of the applications for those three last actions. In the heat map view 1000 shown in FIG. 10, a user has selected to filter the result set to pending cases and final Office Action, RCE and appeal cases.

As shown in FIG. 10, the user has also chosen to organize these heat maps based on the last action taken. This results in a final Office Action heading 1006, an RCE filed heading 1012, and an appeal filed heading 1016. These correspond to final Office Action set 1008, RCE filed set 1014 and appeal filed set 1018. The color scheme corresponding to each of these cases can be explained through the status legend 1022 shown visually in status bar 1024 and explained in status summary 1026. As shown, of the 439 cases retuned, 400 of them are currently under the Examiner average, 30 are at the Examiner's average and 15 are over the Examiner's average. A user may, for example, want to examine more closely these 15 cases that are over the Examiner's average and determine whether or not those cases are worth continuing prosecution. Additionally, a user may choose to save this filter set by selecting the briefcase button 1028, may choose to e-mail the filter set by selecting the e-mail button 1032, may choose to download the filter set by selecting the download button 1034, or may choose to save the filter set by selecting the save button 1036. This ability to filter down to cases compared to an Examiner or art unit average gives a portfolio manager for example at a large corporation the ability to have hands-on management for a very large portfolio that may encompass outside counsel of a variety of firms. The ability to save filter sets to a briefcase and e-mail results to a variety of outside counsel gives a portfolio manager the ability to give tailored directions to outside counsel based on case-specific, Examiner-specific, and art unit-specific needs as opposed to a full, all-encompassing portfolio approach that results in significant budget waste.

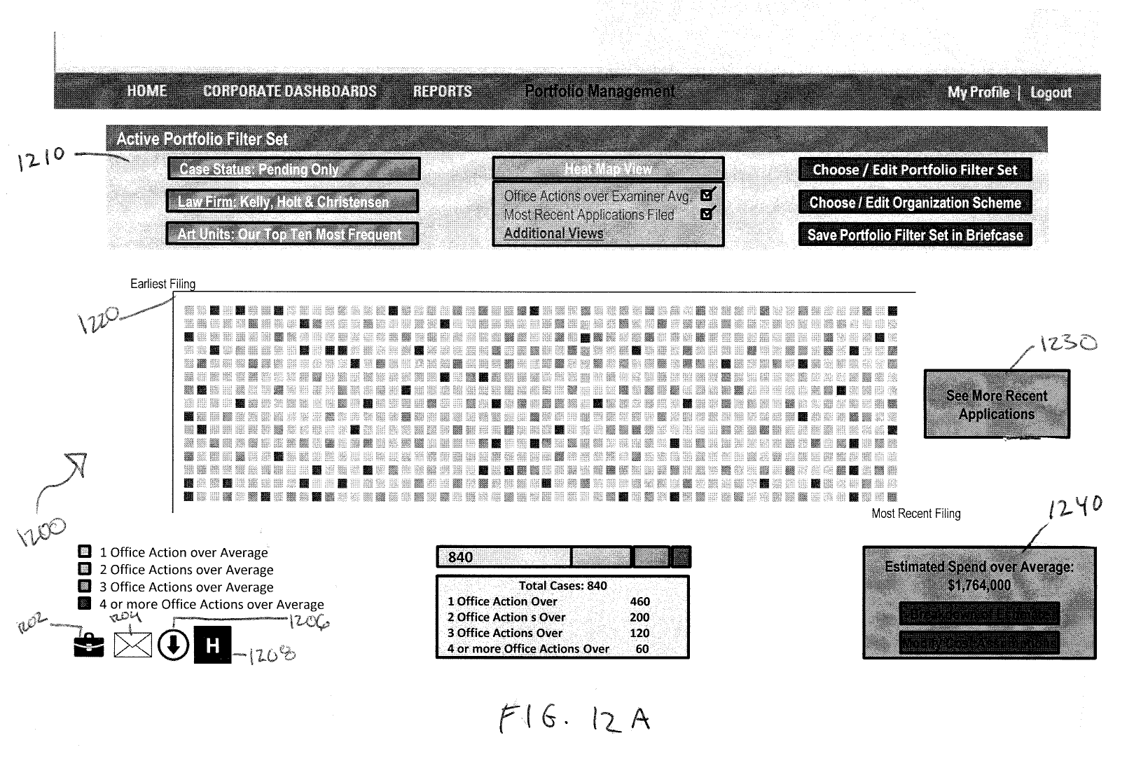

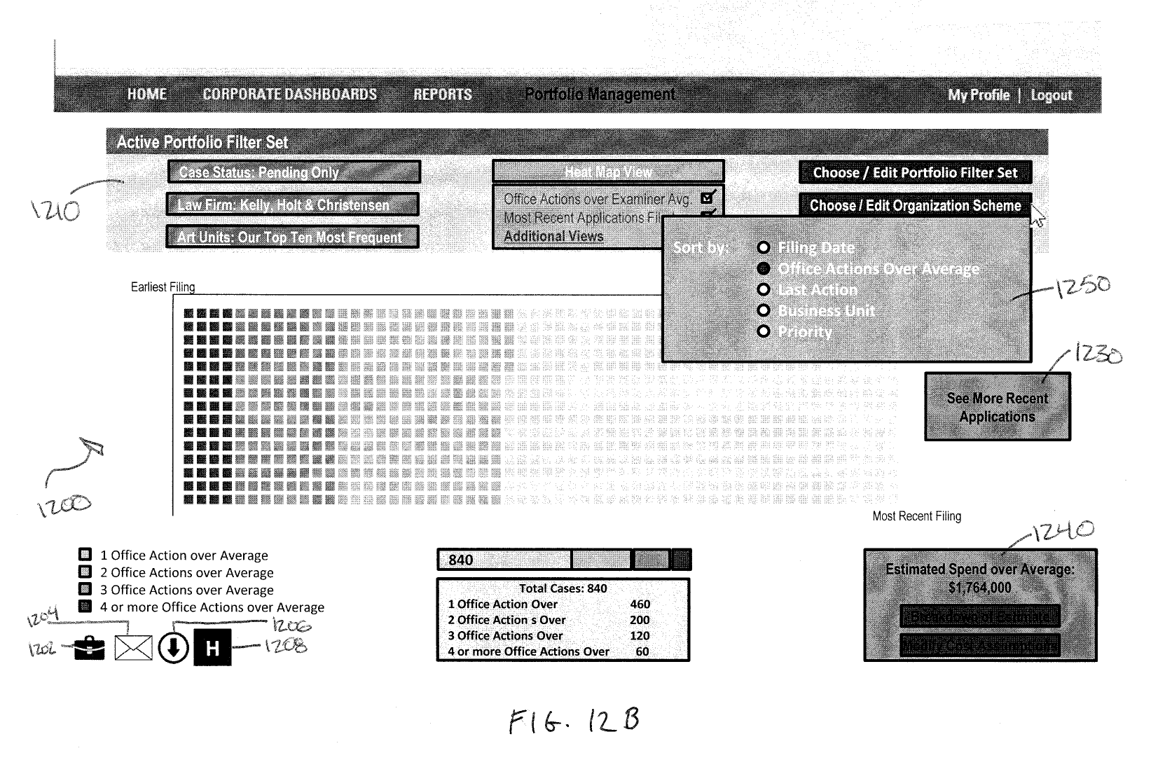

FIG. 11 shows another heat map view 1100 corresponding to another embodiment wherein the heat map selection 1110 shows that a user has now limited the number of cases to Office Actions that are over the Examiner's average. This, in combination with returning only cases that are pending where a last action was a final Office Action, RCE or appeal, has returned only 44 cases. As discussed before, now the number of cases is sufficiently narrowed such that an individual case view icon 1120 appears allowing a user to look through on a page by page basis of the cases that have been returned. Additionally, an icon is now shown in FIG. 11 corresponding to an estimated spend over average indication 1130. Based on the cases shown, the estimated spend over average for this portion of the portfolio is $280,000.00. A user could, for example, determine where this number came from by viewing the assumptions or modifying the assumptions. However, one can understand that, as each response to an Office Action often comprises one to several thousand dollars, the number of cases (for example, as shown in FIG. 11, 28 cases that are more than 5 Office Actions over the Examiner average) contribute significantly to this over average spent. A user now can see more clearly which cases are in need of immediate attention for potential pruning from the budget.

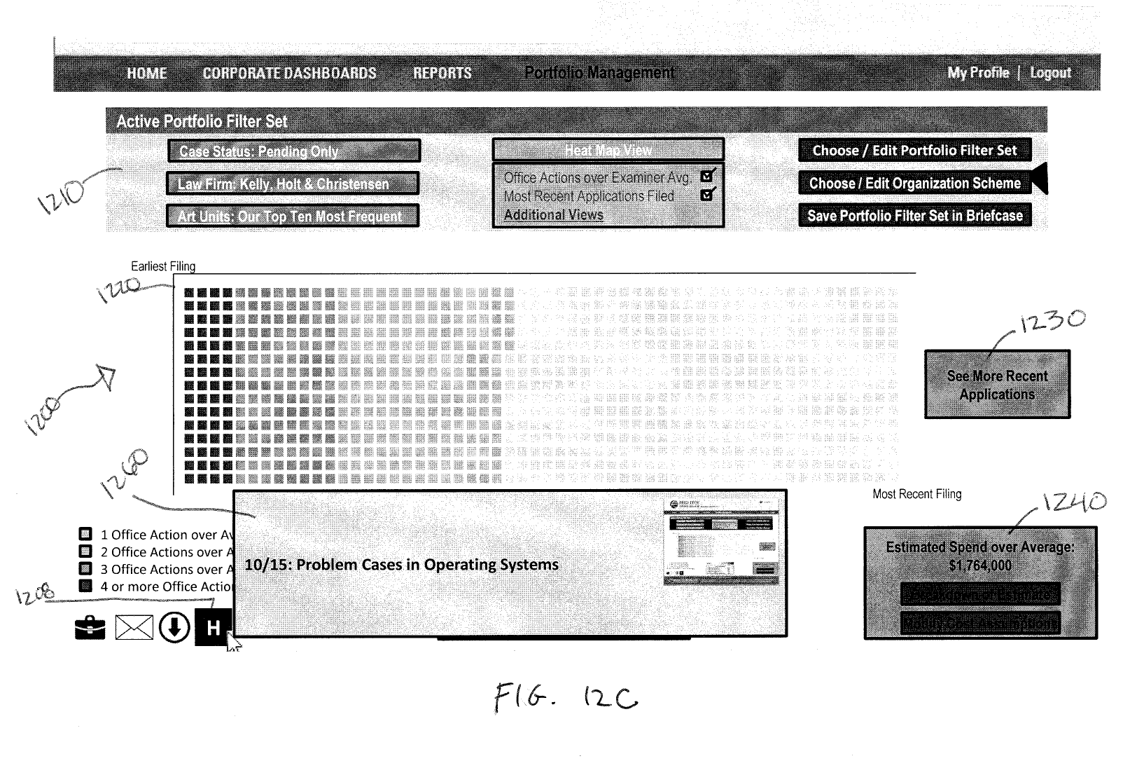

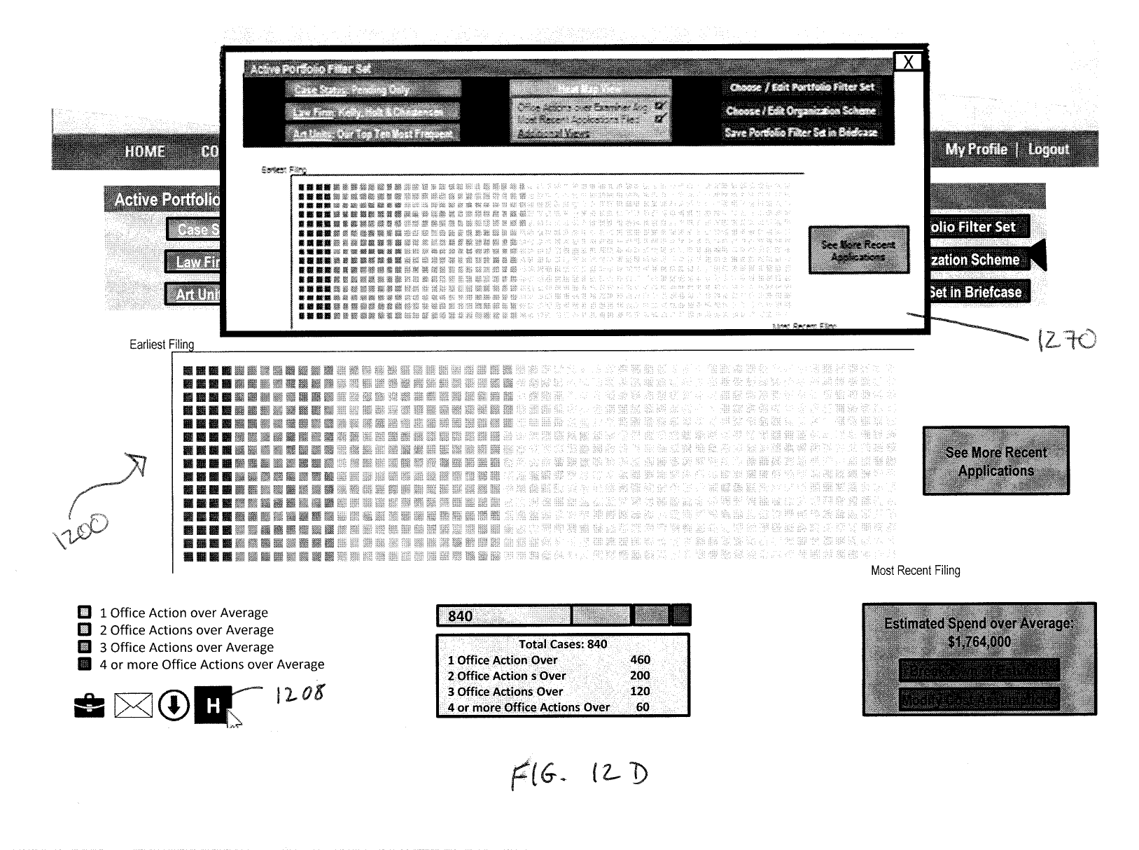

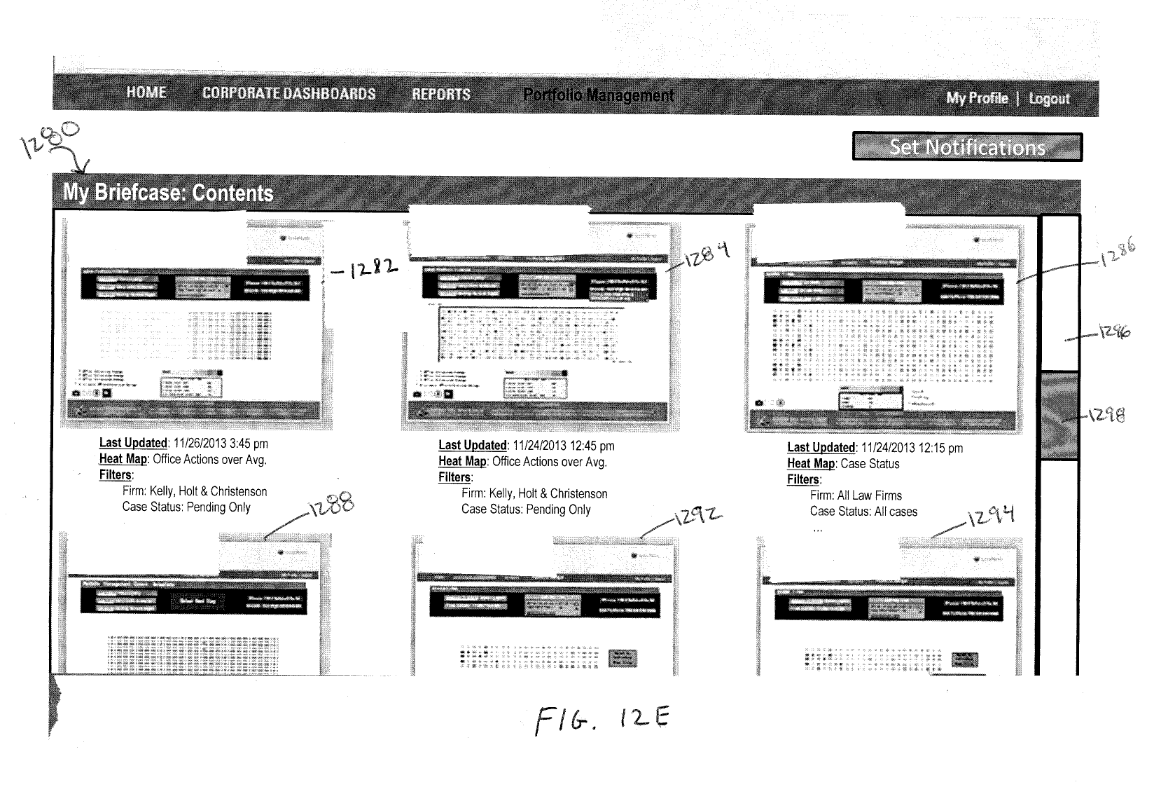

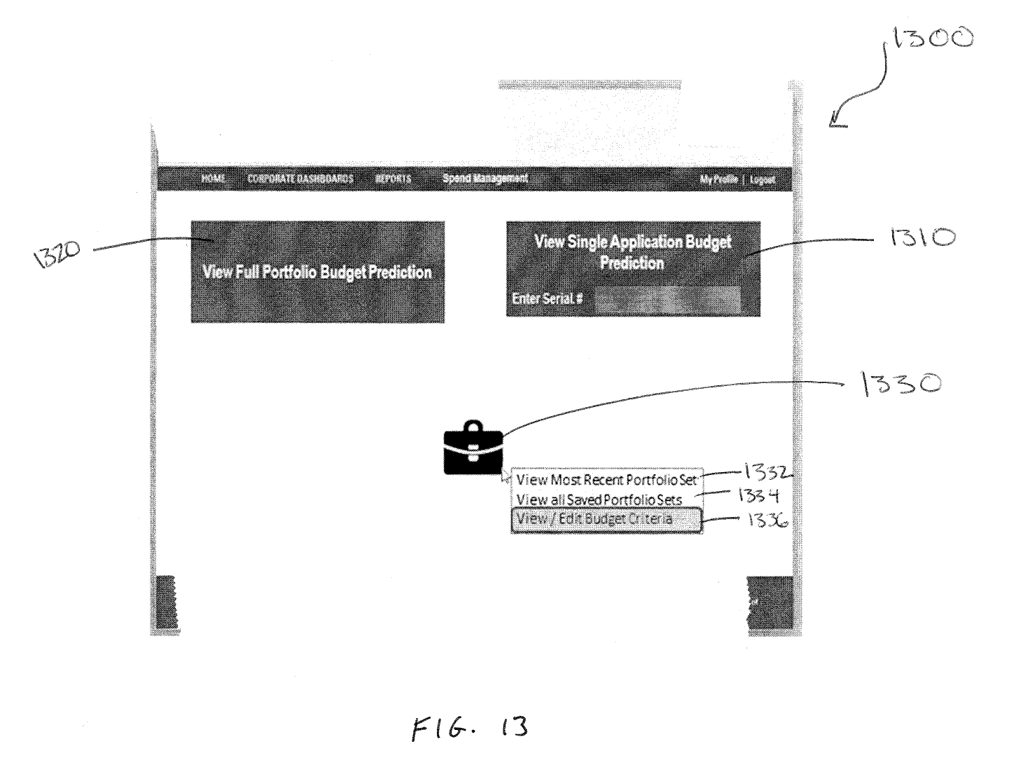

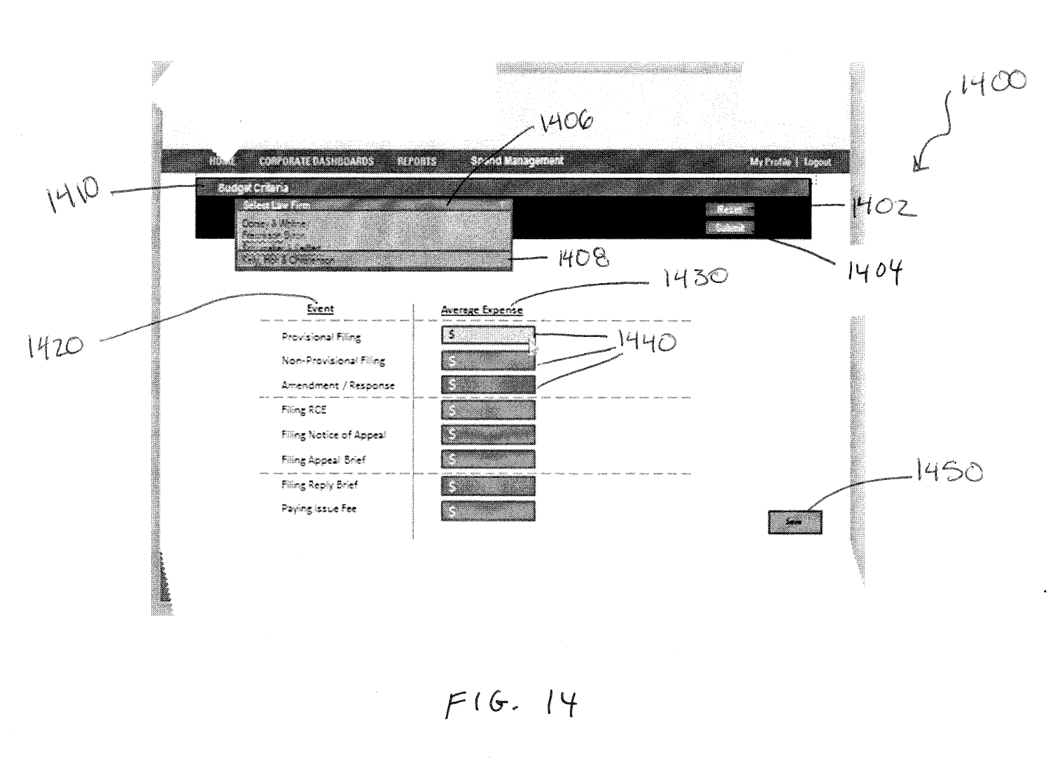

FIGS. 12A-12E illustrate further embodiments. In FIG. 12A a user has selected to view only pending cases and has selected a particular law firm assigned to prosecute their pending cases and has narrowed the cases to view only the cases in their top ten most frequent art units. Here, the term “top ten most frequent art units” signifies the ten art units within the USPTO containing the most applications assigned to the user's company. The heat map view selected is to color the cases by Office Actions over Examiner average and to sort the cases by applications most recently filed. As described previously, at any point a user could choose to edit their portfolio filter set, edit the organizational scheme or save the portfolio filter set to a briefcase 1202. These settings comprise the active filter set 1210.

The applications can be sorted in one embodiment by filing date as shown by axes 1220. As described, the heat map selected are Office Actions over Examiner average in most recent applications filed currently as shown in FIG. 12A. The applications are sorted from earliest filing date to most recent filing date wherein the applications are populated into the heat map shown based on a left to right and then a top to down format such that all of the applications shown in the top line of the heat map were filed before any application shown in the second line of the heat map. In the event that more applications are available than those populating in a graphical view, a see more applications icon 1230 allows a user to page through the applications available or otherwise scroll through the applications available. At any point the user could choose to save this view, e-mail this view, download, or compare to history.

FIG. 12B shows the same application set of FIG. 12A sorted by the number of Office Actions over average as opposed to filing date. These applications are now being populated on a top to down and then left to right fashion. The population metrics could be chosen by a user in one embodiment. As shown in the choose edit organization scheme a user has selected to choose based on Office Actions over average, however, a user could also select to sort by last action, a business unit or priority, wherein both the business unit and the priority sort options may be based on an internal organization scheme. This edit organization scheme 1250 allows a user to truly customize the view of the applications presented to their desire. Additionally, a user may also see an estimated spend over average indication 1240, wherein the estimated spend over average indication 1240 indicates an idea of how much the user has spent on an application set as compared to an average cost The average cost for an application set is based on the average number of Office Actions for each Examiner. For example, for the 60 cases shown where four or more Office Actions have been issued over an Examiner average, each of those Office Actions is indicated to be a set cost that is input into the calculation of estimated spend over average indication 1240. Thus, particularly as shown in FIG. 12B, a user could select and compare different law firms to determine who is most efficiently prosecuting their cases and who is costing them extra money based on the number of Office Actions over average.

FIG. 12C illustrates the visual history 1260. In one embodiment the visual history 1260 shows a date, a brief description and a thumbnail portraying the picture as saved by the system on the date the search was run. The system saves to the history 1208 both the filter set run and a thumbnail image of what the filter set produced in one embodiment. In this way, a user can quickly ascertain whether or not a set of problem cases has gotten better or worse over time. For example, a user can quickly ascertain whether or not the percentage of cases over Examiner average has increased or decreased from the last time the search was run.

FIG. 12D shows a comparative view 1270 wherein a user can use the comparative view 1270 to open a window wherein they can see a larger version of the thumbnail as shown in FIG. 12C to make a better comparison between a then and now view of a particular filter set.

In FIG. 12E, a user may open a briefcase window 1280 that shows a visual depiction of the saved filter sets in the briefcase 1202. FIG. 12E shows six different saved filters, filters 1282, 1284, 1286, 1288, 1292, and 1294. Each of these saved filter sets includes the filters that were run, the date they were run, the heat map used, and a thumbnail of the image produced by the filters. In this way, a user can both visually find a particular filter set that they, for example may want to share with another user, or find the set of filters that they wish to view again. In the event that the briefcase window 1280 contains more saved filter sets than are easily depicted in the briefcase window 1280, a scroll bar 1296 with scroll icon 1298 are provided for a user to scroll through the viewing windows. In one embodiment, a user may select to increase or decrease the view or omit altogether the view of the thumbnail images.

### Spend Management User Interface

As described above with respect to FIGS. 1-12, a user of the portfolio management system can easily search for, view and save a set of cases for later viewing based on a current status. Further, the user can easily organize the cases for better understanding of different aspects of a portfolio. However, another aspect described herein relates to estimating the cost of prosecution of an application, subset of applications, or the entire portfolio. For example, the head of R&D for a particular company may need to provide a financial estimate of prosecuting patent applications for budgeting purposes for a given fiscal year.

The cost of patent prosecution depends primarily on predicting when, and what, actions will occur for a given application within a specified time frame. For example, an application filed on January 1^{st} of Year 1 may only have a filing cost associated with it, as a first office action will likely not be issued for the next few years. Alternatively, an application receiving a Restriction Requirement on January 1^{st} of Year 1 will incur at least the costs of responding to the costs of that Restriction Requirement and likely will also receive another action, for example a Non-Final Office Action before January 1^{st} of Year 2. Depending on the speed at which the applicant files a response to the first Restriction Requirement and the Non-Final Office Action, and the speed at which the Examiner for the application issues the Non-Final Office Action and analyzes the responses, another Office Action may also issue before January 1^{st} of Year 2. Further, the cost of responding to a Restriction Requirement may be different for a given application than the cost for responding to the Non-Final Office Action. Therefore, the ability to predict how many actions, what types of actions, and when the actions will be received, and when they will be billed, is crucial to generating a Spend Management prediction for a user.

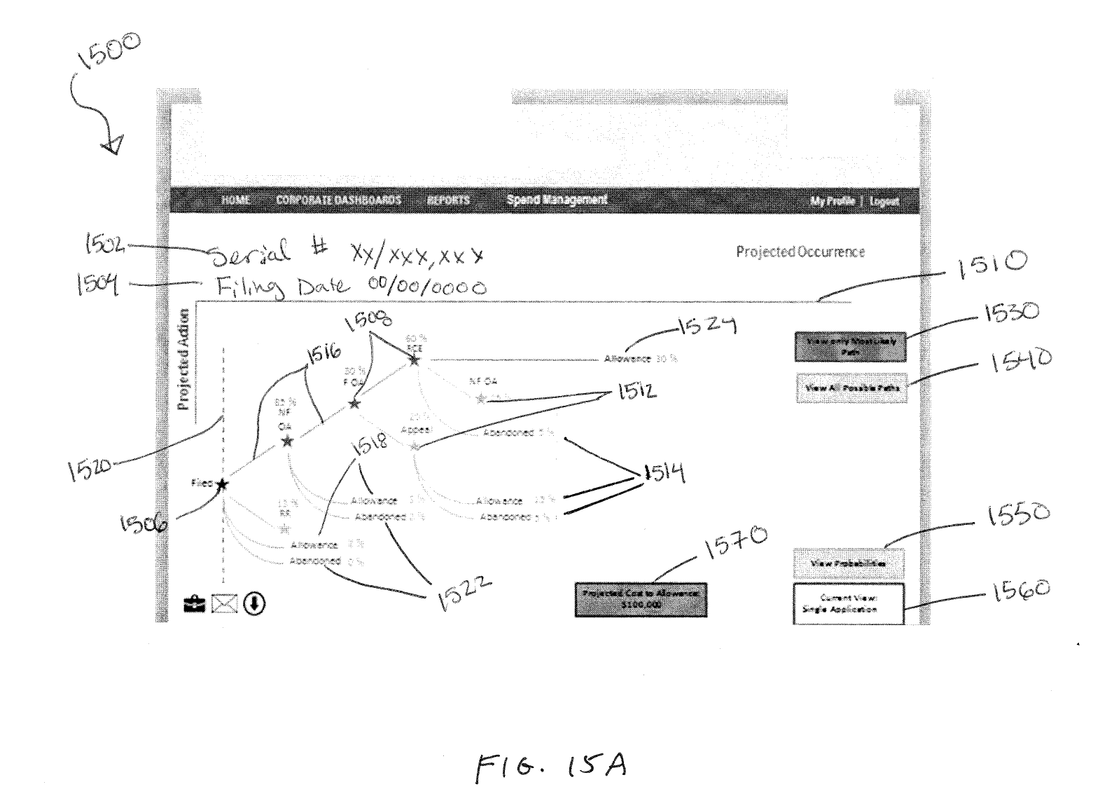

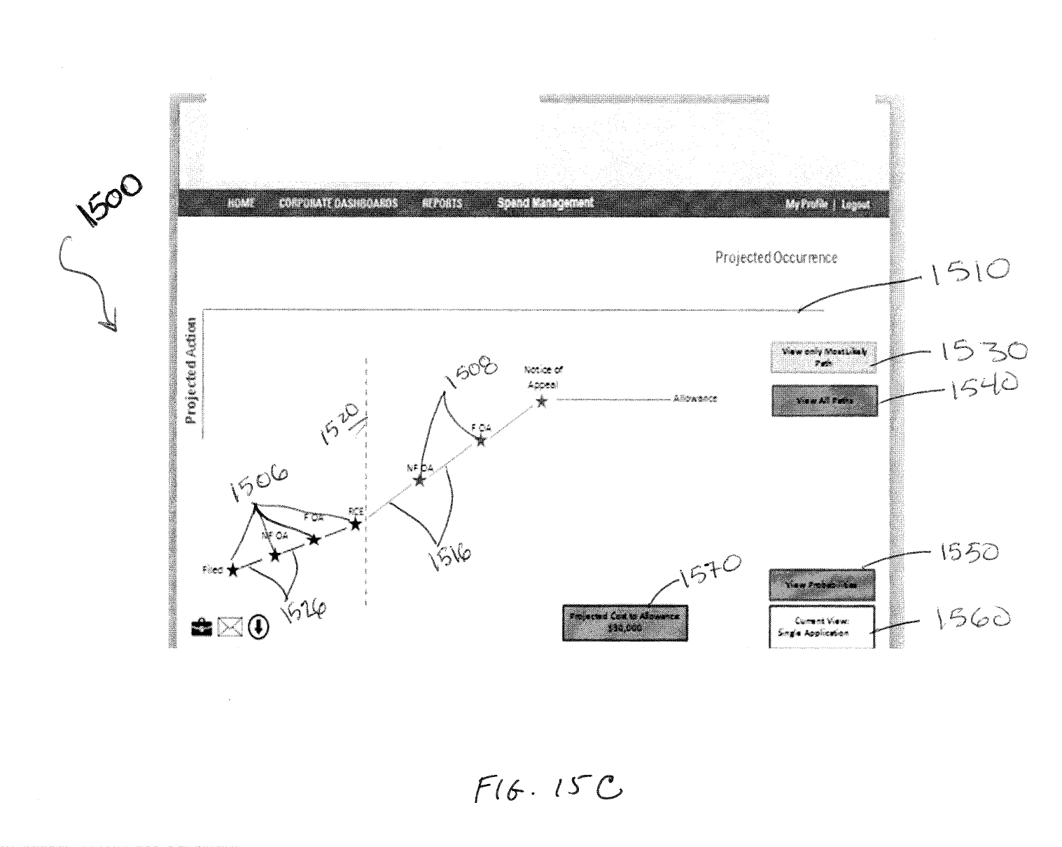

In some embodiments, a computer implemented method of displaying a graphical representation of a plurality of predicted prosecution events for a patent application includes receiving, by a processor, a request to generate the graphical representation of the plurality of predicted prosecution events for the patent application (e.g., in response to a user selecting a view single application budget prediction button 1310, as shown in FIG. 13). The method further includes predicting the plurality of predicted prosecution events for the patent application, which may involve accessing the database to aggregate statistics for cases before the same Examiner, cases in the same art unit, cases including similar keywords, or the like. The method further includes in response to receiving the request to generate the graphical representation, automatically displaying the graphical representation of the plurality of predicted prosecution events for the patent application on a display device (e.g., a display device of a client computing device used to access the portfolio management system described herein). As shown in FIG. 15A, the graphical representation includes a plurality of nodes (e.g., “NF OA,” “F OA,” “RCE”, etc. nodes). Each of the plurality of nodes corresponds to one of the plurality of predicted prosecution events. In some embodiments, a projected cost of prosecution for the patent application based on the plurality of predicted prosecution events is calculated. The cost may be calculated based on the predicted prosecution events and cost estimate data included in the database for the predicted prosecution events. In some embodiments, the cost may be calculated based on a law firm prosecuting the patent application, such as when an average cost for the law firm to handle each of the predicted prosecution events is used as an estimate for each of the predicted prosecution events, and the cost estimates are totaled to arrive at the cost of prosecution for the patent application. A graphical representation of the projected cost of prosecution may be displayed on the display device, such as shown in the projected cost indication 1570 shown in FIG. 15A.

FIG. 13 presents a spend management view 1300 that allows a user to choose to view particular details about their spend management by selecting the view single application budget prediction button 1310 or a portfolio view button 1320. The user may also choose to view previously viewed items on the spend management view via briefcase 1330, which may allow the user to choose to view a recent set, to view a saved set, or to edit budget criteria.

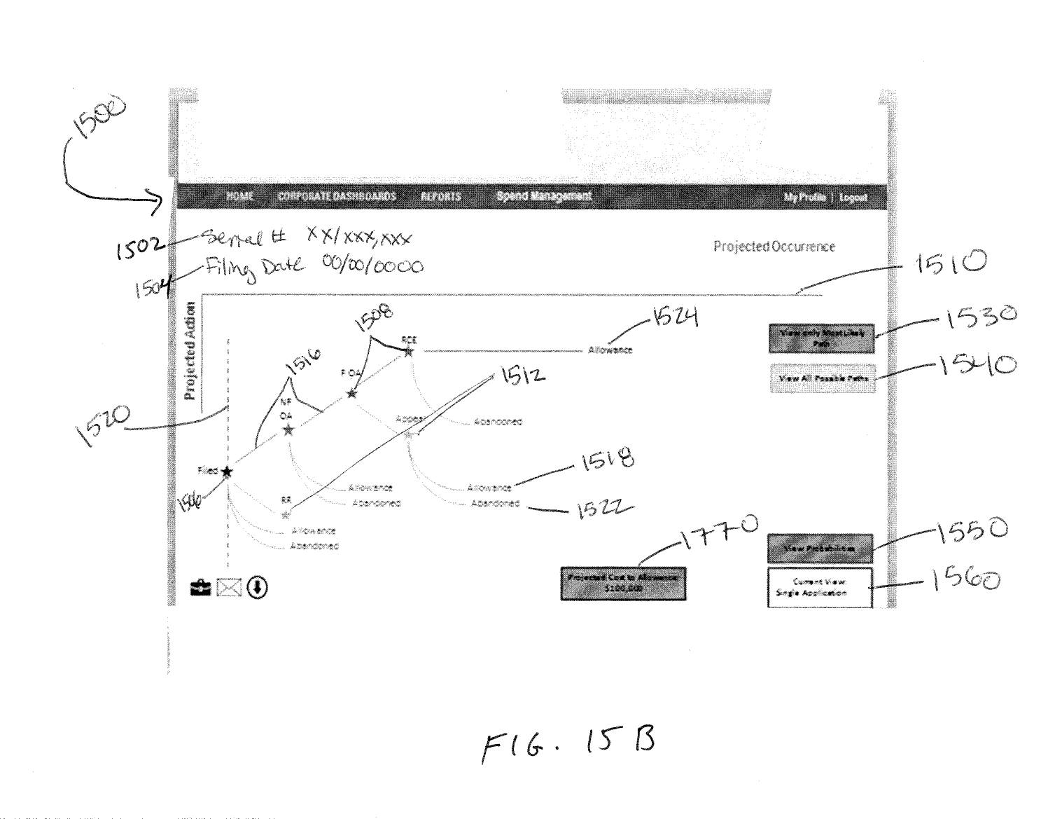

Should a user choose to edit budget criteria by selecting the view/edit budget criteria button 1336 as provided in FIG. 13, they may be taken, in one embodiment, to a budget criteria view 1400 as shown in FIG. 14. Depending on how large the user's corporation is, they may employ several different law firms to prosecute their patent applications with the USPTO. In one embodiment, each of these individual law firms may have different criteria for expenses related to different filings. These expenses may, for example, relate to geographical location of the law firms or specialty of the law firms. In one embodiment, a user actuates a selection mechanism 1406 to choose a selected law firm 1408.

In the budget criteria view 1400, the user is presented with a possible event column 1420 and an average cost column 1430. Depending on how a corporation assigns costs for different potential events, the user can enter a project expense 1440 for each of the potential events listed in the possible event column 1420. Some of the costs may, in one embodiment, be populated by the budget criteria view 1400. For example, fees associated with filing a non-provisional application with the USPTO may be populated based on a known size of the entity, for example large or small entity. Additionally, fees associated with filing an RCE (Request for Continued Examination) or a Notice of Appeal may also be populated and updated by the system as those costs change based on the USPTO's fee schedule.

Once a user has entered average expenses for each of these potential expenses, the user may save the criteria by selecting save button 1450. Additionally, the user is presented with the option to reset by selecting the reset button 1402 or submit criteria for a law firm and then move to, using the selection mechanism 1406, to select a different law firm. Additionally, while budget criteria view 1400 only shows the selection of a law firm, a user may also choose to select business units or art units, for example if a user notes that it pays significantly less for amendments and responses related to software technology as opposed to hardware technology, a user may choose to change projected expenses based on that criteria instead of based on a law firm by law firm basis.

The user interfaces described herein may also allow a user to see a projected budget for an individual case or a selected subset of cases in the portfolio. The user interface is able to populate based on an average occurrence pattern in an art unit, for an Examiner, and for a specific company, a projected path to allowance or abandonment based on an individual case. For an individual case, this is shown in FIG. 15 through case budget view 1500, where an exemplary application number 1502 with filing date 1504 is shown. The timeline 1510 may, in one embodiment, show the actual projected time, for example between a filing date and a first Office Action, or it may show an exemplary timeline where the distance between each event is fixed. The view may, in one embodiment, be a date-based timeline or an event-based timeline depending on the setting chosen by the user. As shown through FIG. 15, the timeline 1510 is shown in an event-based timeline.

A user has the option to choose to view either only the most likely path for a given application, through view most likely path button 1530, or a user may choose to view all possible paths for an application through the view all paths button 1540. Depending on what the user chooses, the system will show only the most likely path to allowance or abandonment or all possible paths to different possible outcomes. Additionally, a user can choose to view probabilities associated with each potential event through view probabilities icon 1550. The probabilities associated with different possible paths, especially the probabilities surrounding a fork in the timeline, may be useful to a user, for example in deciding whether to file an RCE or an Appeal after a Final Office Action.

A current view icon 1560 is provided to show a user what the basis is for the current view. Additionally, a projected cost indication 1570 shows the projected cost of carrying an application from the current position through to the most likely outcome, in this case an allowance. This allows a user to determine whether or not, even if a case will reach allowance as opposed to abandonment, is worth the projected cost to get there. Additionally, if it is more likely than not that the case will be eventually abandoned, the projected cost indication 1570 will indicate the project amount of money that will be wasted before the case is closed.

For events that have already occurred, for example the filing date associated with an application as shown in FIG. 15A, an occurred event icon 1506 is shown to the user. For events that are predicted to occur, predicted event icons 1508 are shown. For events that are predicted not to occur, predicted non-event icons 1512 are provided. For each event, either predicted to occur or predicted not to occur, a probability of occurrence indication 1514 is provided. Additionally, for events that are projected to occur, a projected event timeline 1516 is provided that indicates the order in which these events will occur. For each event that is predicted by the case budget view 1500, there is an opportunity for allowance or abandonment. For this reason, an allowance indication 1518 and an abandonment indication 1522 is provided along with a probability of occurrence indication 1514 for each potential event.

For many exemplary patent applications moving through the prosecution process, the process starts with a filing of an application and ends with an allowance or abandonment. However, between the filing date and the eventual case outcome, there are many different permutations for a case to take thus resulting in a plurality of potential timelines. At each stage of the prosecution, a response filed by an Applicant or the Applicant's Representative could result in a potential allowance or potential abandonment either express or otherwise. As shown, the case budget view 1500 projects the possibility of each of these events but follows the projected event timeline 1516. The projected event timeline for the exemplary application as shown in FIG. 15A, is that after the filing is indicated on the current date axis 1520, it will first receive a non-final Office Action with the probability of that path being 85%. Alternatively, instead of a first non-final Office Action, the case could be immediately allowed indicated with a 2% allowance rate or abandoned by the Applicant indicated with substantially 0% allowance rate. Another option would be for the case to receive a Restriction Requirement indicated here with a 13% chance of occurrence.

Assuming that the application does receive the predicted first non-final Office Action indicated with an 85% rate of probability, the next most likely event is a final Office Action indicated with an 80% probability. Other potential options after a first Non-Final Office Action would be for a second non-final Office Action or a Restriction Requirement which are not shown here as their likelihood of occurring is substantially 0% for the exemplary case. Alternatively, after this first non-final Office Action, there is a 3% chance of an allowance after a response and a 2% chance of abandonment without a response.

Notably, after the predicted first final Office Action, there are two options for an Applicant. The Applicant may choose to file an RCE which, based on the Applicant's history for example as compared to this particular Examiner or art unit assigned to this application is associated with a 60% probability of occurrence, or the Applicant may choose to file an Appeal which is indicated with having a 20% chance of probability. It is indicated that if the Applicant files an Appeal, based on the Appeal statistics for this Examiner and art unit assigned to this particular case there is a 15% chance of allowance and a 5% chance of abandonment. It is noted that these percentages are fractional percentages of the 20% likelihood that the Applicant will choose to file an Appeal. Therefore, an Applicant can use this case budget view 1500 to determine whether or not it would be better to file an Appeal or file an RCE based on the likelihood of allowance. It is indicated that should an Applicant file an RCE the chance of getting allowance is also equivalent to the chance of getting a second non-final Office Action. Alternatively, should the Applicant choose to file an Appeal, the chance of getting an allowance is three times as high as the case eventually being abandoned as indicated in FIG. 15A. This may indicated to an Applicant that it may be better to file an Appeal as opposed to filing an RCE as the chance of immediate allowance is greater after the filing of the Appeal than after the RCE.

FIG. 15B shows the same projected event timeline 1516 as shown in FIG. 15A; however, here the Applicant has chosen to unselect the view probabilities icon 1550 and thus the predicted event icons 1508 and the predicted non-event icons 1512 are shown without the potential probabilities. This may be helpful to a user in the event that the screen appears cluttered because of the inclusion of the probabilities. In one embodiment, deselecting the view probabilities icon 1515 first removes probabilities associated with predicted non-events and, upon a second selection, removes the probability of occurrence indication 1514 associated with predicted event icons 1508. In another embodiment, deselecting the view probabilities icon 1515 removes all probabilities with a first selection.

FIG. 15C shows a different exemplary application view where a user has chosen to view a most likely path by selecting the view only most likely path button 1530 as opposed to view all paths by selecting the view all paths button 1540. This removes the predicted non-event icons 1512 from the screen. It is also shown in FIG. 15C that this exemplary case is being viewed not at a filing date 1504, but at a later date indicated by current date axis 1520. Events that have occurred are indicated by occurred event icon 1506 which is different than predicted event icons 1508. In one embodiment, these icons may differ based on color whereas in another embodiment they may be distinguished based on shading or based on shape.

In one embodiment, while the case budget view 1500 may predict a particular projected event timeline 1516; that may not always be the prosecution path that a case actually follows. This may change, as described in one example where a user chooses to file an Appeal instead of an RCE based on the projected likelihood of allowance vs. abandonment. However, in another embodiment, this event may occur as a result of an Examiner at the USPTO taking a non-predicted action.

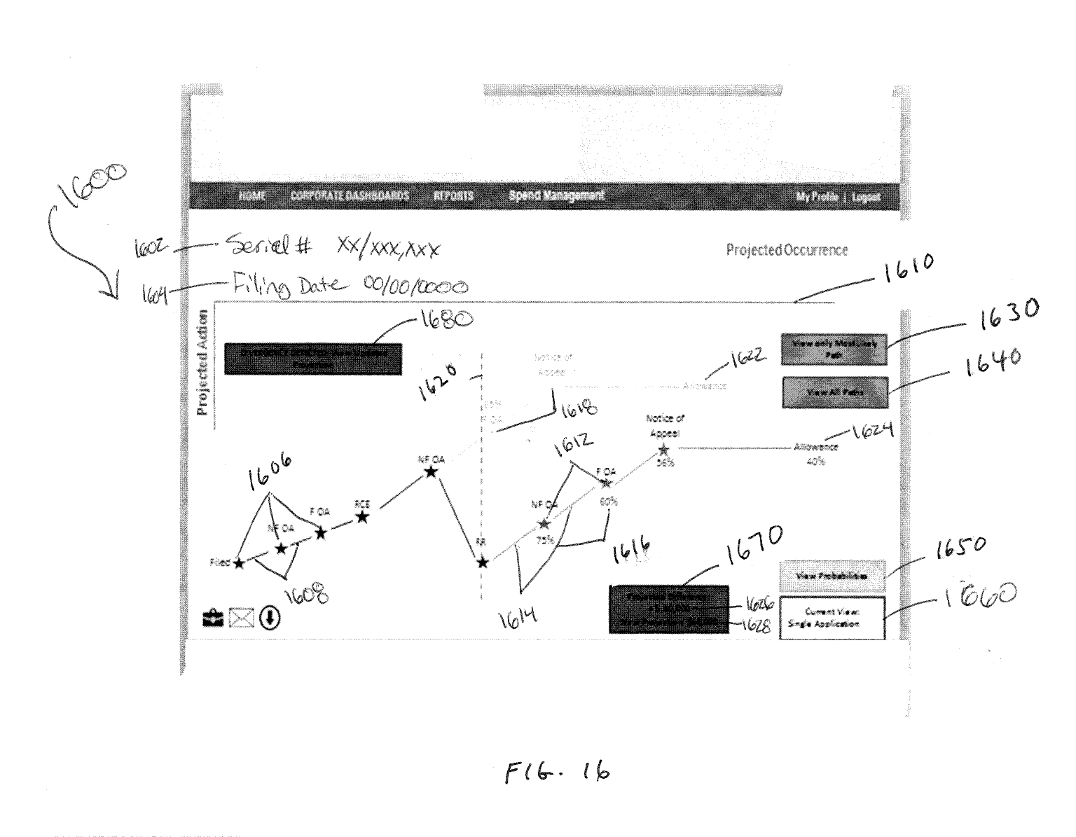

As shown in FIG. 16, in a case budget view 1600, a timeline 1610 shows that an action has occurred that was not predicted. In the view of FIG. 16, it is noted that a divergence indicator 1680 has shown that a divergence has been detected from the projected path to the new path as shown whereas the last event was a non-final Office Action it was predicted, with a 65% chance of likelihood, that the next action would have been a final Office Action. However, as a result of the amendment filed by a user in this particular case, a Restriction Requirement was issued by the United States Patent Office. As a result, the occurred timeline 1608 diverges into a new predicted event timeline 1612 and what had been the predicted events are now indicated as predicted nonevents 1618.

In the case budget view 1600 shown in FIG. 16, a user has chosen to view only most likely path as opposed to view all paths. However, as a divergence has been detected, the original most likely path is shown in a grayed-out fashion to indicate when the indicated change was detected, and what the new path of the application is predicted to be. The user has also chosen to view probabilities associated with the projected events through view probabilities icon 1650. Additionally, the user can see through current view icon 1660 that they are still only viewing a single application. As a result of the divergence, the projected cost associated with the application having serial number 1602 with filing date 1604 will change. As shown, the projected cost 1626 of the divergence in this case is projected at $30,000.00 and the projected overall case cost 1628 is projected to be $60,000.00. This projected divergence cost and projected case cost is based on the estimated budget criteria as shown in one embodiment as entered through the interface of FIG. 13. Also shown in the case budget view 1600 is the predicted non-case outcome 1622 and the new predicted case outcome 1624. In one embodiment, as a result of the divergence, these predicted non-case outcome 1622 and the new predicted case outcome 1624 may be the same or different. For example, in one embodiment, when a divergence is detected it results in a more likely than not that the case will eventually be abandoned as opposed to allowed or, in another embodiment, may indicate that the case is now more likely to be allowed as opposed to abandoned.

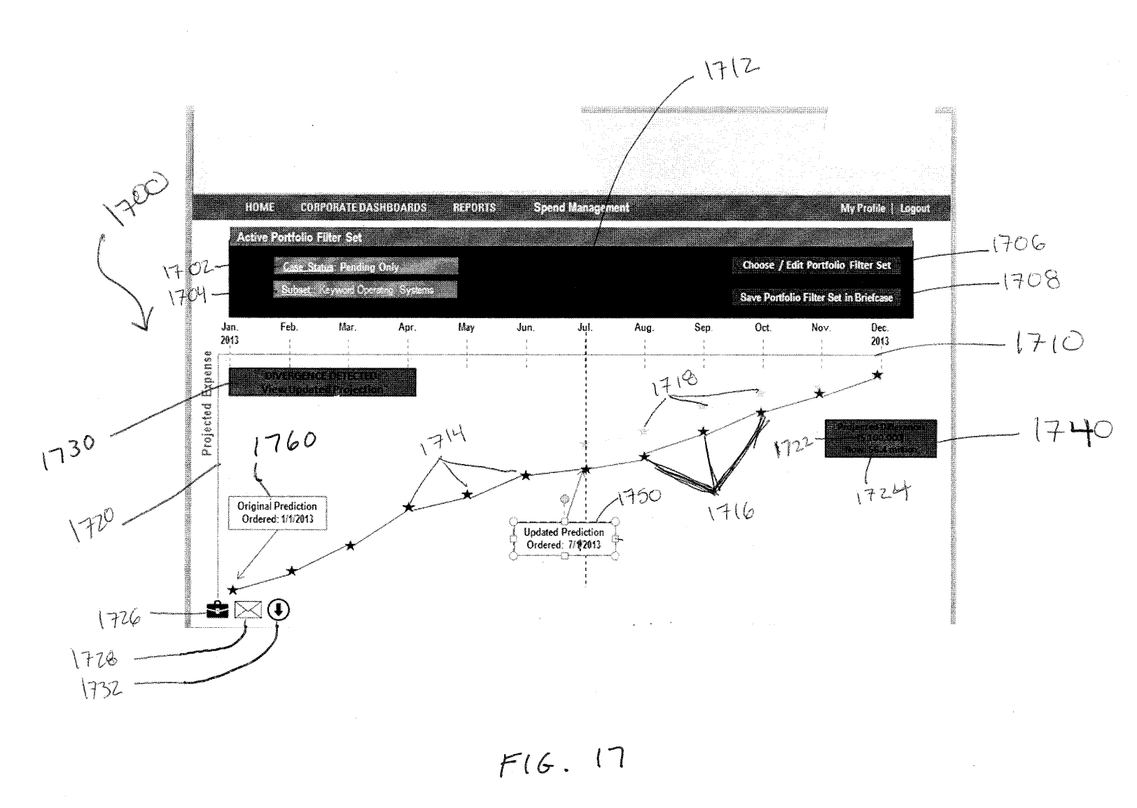

FIGS. 15 and 16 show case budget views with only one application. However, for corporations prosecuting multiple applications at a time with the USPTO, it is envisioned that they may want to view projected cost associated with their entire portfolio as opposed to with only one case at a time. FIG. 17 shows a portfolio budget view 1700 with a timeline 1710. In one embodiment, a corporation may set the timeline 1710 to reflect their fiscal year. However, as shown in FIG. 17, a timeline showing dates for the months of 2013 is shown for convenience.

A projected expense axis 1720 is shown against the timeline 1710. This projected expense axis 1720 may, in one embodiment, include a plurality of tick marks for different expense levels during the year. In one embodiment, an original prediction date 1760 is indicated wherein the original prediction date 1760 shows the date on which the prediction for a current fiscal year was first ordered. Additionally, a divergence date 1750 is shown against a current date axis. In one embodiment, it is expected that events for individual cases will vary from those predicted as shown in FIG. 16 and therefore it will be convenient for the user to order updated predictions throughout a fiscal year to determine whether or not their budget is still on track, or whether it needs to be revised based on the detected divergence.

In one embodiment, the user may choose to alter the portfolio being shown via case inclusion icon 1702 and subset viewing 1704 to pinpoint where in the budget for example costs are greatly exceeding what had been predicted. In this way, a user may determine why their budget is not following the predictions. For example, in one embodiment, the algorithm may predict that a case will not receive an Office Action from an RCE for a projected period of time. However, if a particular art unit or Examiner decides to focus on decreasing their RCE backlog, this could result in an early return of a plurality of RCEs faster than anticipated. By viewing different subsets of applications, the user can determine that this is a change relative to a particular Examiner, art unit, or across the USPTO as a whole and may need to alter their budget accordingly.

Alternatively, a user may note that a specific law firm is filing responses to received Office Actions significantly past the three-month due date and thus incurring both extension times and throwing off predictions for when later Office Actions will come in. In one embodiment, a user can, as described previously, save a portfolio set to briefcase through save button 1708 or edit a particular portfolio set being viewed through edit button 1706. The user can save the cases to briefcase button 1726, e-mail the particular view through e-mail button 1728, or download the view through download button 1732. In this way, the user may indicate to the specified law firm a specific fiscal amount associated with their late responses on the corporate portfolio and, thus, force a change in the specified law firm's prosecution behavior.

The user may also see, through the portfolio budget view 1700, a plurality of different icons indicating actual costs 1714, old predicted costs 1718, and new predicted costs 1716. These icons may differ based on color, shading or shape and these differences may be programmable by a user through a settings menu or may be preset by the portfolio budget view 1700. In one embodiment, the actual costs 1714 show what the actual costs were based on events that have occurred between the original prediction date 1760 and the divergence date 1750. These costs may be shown on a month-to-month basis wherein the costs reflect a total year-to-date cost over time or they may be shown in a month-to-month basis where the cost shown is based on current costs for that month and may be shown instead of a line graph through a bar chart. The new predicted costs 1716 are shown in a different indication format than the old predicted costs 1718. Additionally, a new fiscal cost 1724 is projected based on the detected divergence and a projected difference 1722, as shown. Often, the fact that a divergence has been detected may not actually result in a huge projected difference for a fiscal year as the divergence may be as simple as an Office Action coming a month early and thus creating a higher cost, for example for the month of June, but wherein that Office Action cost is now associated with June as opposed to October and may, therefore, not result in a large cost change overall for an entire fiscal year.

It should be understood that the methods for displaying a graphical representation of a classification of a set of patent applications into a plurality of categories according to an attribute, as described herein, may allow a user may quickly and efficiently understand characteristics of the set of patent applications based on viewing the graphical representation. Furthermore, the methods for displaying a graphical representation of a plurality of predicted prosecution events for a patent application, as described herein, may allow a user to quickly and efficiently understand a predicted course of prosecution of one or more patent applications by viewing the graphical representation.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer implemented method for displaying a graphical representation of a classification of a set of patent applications into a plurality of categories according to an attribute, the method comprising:
receiving, by a processor, a request to generate the graphical representation of the classification of the set of patent applications into the plurality of categories according to the attribute; and
in response to receiving the request to generate the graphical representation, automatically displaying the graphical representation of the classification of the set of patent applications into the plurality of categories according to the attribute on a display device, wherein the graphical representation includes a plurality of patent document icons, wherein each of the plurality of patent document icons corresponds to one of the set of patent applications, wherein each of the plurality of patent document icons graphically represents that the patent application associated with the patent document icon is classified in a category of the plurality of categories.

2. The computer implemented method of claim 1, wherein the graphical representation is a heat map graphical representation.

3. The computer implemented method of claim 2, wherein each of the plurality of patent document icons graphically represents that the patent application associated with the patent document icon is classified in a category of the plurality of categories based on a color of the patent document icon.

4. The computer implemented method of claim 1, wherein the heat map graphical representation includes the plurality of patent document icons arranged in a grid.

5. The computer implemented method of claim 4, wherein the plurality of patent document icons are sorted in the grid by at least one organizational parameter.

6. The computer implemented method of claim 1, wherein:
the attribute is an application status;
the plurality of categories include an issued patent category, a pending application category, or an abandoned application category; and
each of the plurality of patent document icons graphically represents that the patent application associated with the patent document icon is classified in the issued patent category, the pending application category, or the abandoned application category.

7. The computer implemented method of claim 1, wherein:
the attribute is a patent prosecution metric;
the plurality of categories include a plurality of patent prosecution metric categories; and
each of the plurality of patent document icons graphically represents that the patent application associated with the patent document icon is classified in one of the patent prosecution metric categories.

8. The computer implemented method of claim 1, wherein the set of patent applications are filtered from a universe of patent applications according to at least one filter criteria.

9. The computer implemented method of claim 8, wherein the at least one filter criteria includes an examiner filter, an art unit filter, an examiner allowance rate filter, an art unit allowance rate filter, an office actions over average filter, a top art units filter, a number of RCEs filter, an inventor filter, a law firm filter, a technology area filter, a priority filter, a last action filter, or a status filter.

10. A computer implemented method of displaying a graphical representation of a plurality of predicted prosecution events for a patent application, the method comprising:
receiving, by a processor, a request to generate the graphical representation of the plurality of predicted prosecution events for the patent application;
predicting the plurality of predicted prosecution events for the patent application; and
in response to receiving the request to generate the graphical representation, automatically displaying the graphical representation of the plurality of predicted prosecution events for the patent application on a display device, wherein the graphical representation includes a plurality of nodes, wherein each of the plurality of nodes corresponds to one of the plurality of predicted prosecution events.

11. The computer implemented method of claim 10, further comprising:
calculating a projected cost of prosecution for the patent application based on the plurality of predicted prosecution events; and
displaying a graphical representation of the projected cost of prosecution on the display device.

12. The computer implemented method of claim 11, wherein the projected cost of prosecution for the patent application is calculated based on a law firm prosecuting the patent application.
